(19) United States
(12) Patent Application Publication
(10) Pub. No.: US 2019/0129583 A1
(43) Pub. Date: May 2, 2019

(54) INFORMATION PROCESSING DEVICE AND NON-TRANSITORY COMPUTER READABLE MEDIUM

(71) Applicant: FUJI XEROX CO., LTD., Tokyo (JP)

(72) Inventors: Masahiro YAMADA, Kanagawa (JP); Takeshi KUNIMASA, Kanagawa (JP); Atsushi MARUYAMA, Kanagawa (JP); Naoki OKAMOTO, Kanagawa (JP)

(73) Assignee: FUJI XEROX CO., LTD., Tokyo (JP)

(21) Appl. No.: 16/165,085

(22) Filed: Oct. 19, 2018

(30) Foreign Application Priority Data
Nov. 2, 2017 (JP) 2017-212360

(51) Int. Cl. G06F 3/0482; G06F 17/30; G06F 3/0484

(52) U.S. Cl. CPC G06F 3/0482; G06F 3/0484; G06F 17/30011

(57) ABSTRACT

An information processing device includes a storage processing unit that, in a case of storing a document or a copy of the document inside a storage area in a different specific storage area, executes a process of setting information indicating the storage area in an attribute indicating an original storage location of the document to store, and storing the document in the specific storage area.

### CROSS-REFERENCE TO RELATED APPLICATIONS

This application is based on and claims priority under 35 USC 119 from Japanese Patent Application No. 2017-212360 filed Nov. 2, 2017.

### BACKGROUND

### Technical Field

The present invention relates to an information processing device and a non-transitory computer readable medium.

### SUMMARY

According to an aspect of the invention, there is provided an information processing device including a storage processing unit that, in a case of storing a document or a copy of the document inside a storage area in a different specific storage area, executes a process of setting information indicating the storage area in an attribute indicating an original storage location of the document to store, and storing the document in the specific storage area.

### BRIEF DESCRIPTION OF THE DRAWINGS

An exemplary embodiment of the present invention will be described in detail based on the following figures, wherein:

FIG. 1 is a diagram illustrating an example of a schematic configuration of a document management system applying character recognition process control according to the exemplary embodiment;

FIG. 2 is a diagram illustrating an example of a document management screen provided by the document management system;

FIG. 3 is a diagram illustrating an example of a document management screen displaying a context menu that includes the menu item “Copy to workspace” with respect to a document icon;

FIG. 4 is a diagram illustrating an example of a document management screen illustrating a workspace after a new document is copied;

FIG. 5 is a diagram illustrating an example of a document management screen displaying a context menu (the menu item “Copy to workspace” is not included) with respect to a folder icon;

FIG. 6 is a diagram illustrating an example of an error notification screen displayed in the case of executing an operation of copying a folder to the workspace;

FIG. 7 is a diagram illustrating an example of a query screen displayed in the case of executing an operation of copying a folder to the workspace;

FIG. 8 is a diagram illustrating an example of a query screen displayed in the case of executing an operation of copying a folder to the workspace in another example;

FIG. 9 is a diagram illustrating an example of a screen for setting the folder to open on startup of the document management system;

FIG. 10 is a diagram illustrating an example of a display control procedure on startup of the document management system;

FIG. 11 is a diagram illustrating an example of a document management screen displayed when the document management system is started up, after a document is registered in the workspace while the document management system is shut down;

FIG. 12 is a diagram illustrating an example of a document management screen displaying an information view for a document;

FIG. 13 is a diagram illustrating an example of a document management screen reflecting information about the copy source location of each document in the display of the icon of each document inside the workspace opened in a document pane;

FIG. 14 is a diagram illustrating an example of a document management screen displaying an Internet URL as the copy source location in the information view for a document;

FIG. 15 is a diagram illustrating an example of a document management screen that displays document icons grouped according to the copy source location;

FIG. 16 is a diagram illustrating an example of a document management screen displaying a document context menu including a menu item for opening the copy source location (folder);

FIG. 17 is a diagram illustrating an example of a document management screen listing documents inside the workspace, and documents in the copy source folder of a document among the documents inside the workspace;

FIG. 18 is a diagram illustrating an example of a document management screen displaying a context menu including the menu item “Clean up” as the context menu of the workspace;

FIG. 19 is a diagram illustrating an example of the procedure of a process for cleaning up the workspace by a cleanup processing section;

FIG. 20 is a diagram illustrating an exemplary display of a cleanup dialog;

FIG. 21 is a diagram illustrating an example of a document management screen displayed after the cleanup process;

FIG. 22 is a diagram illustrating an example of a document management screen displaying a context menu including a “Return to workspace” menu item for a cleanup folder;

FIG. 23 is a diagram illustrating an example of a procedure of a processor for returning a cleanup folder by the cleanup processing section;

FIG. 24 is a diagram illustrating an example of a dialog displayed during the process of returning a cleanup folder;

FIG. 25 is a diagram illustrating an example of a document management screen including a button that indicates cloud synchronization of the workspace;

FIG. 26 is a diagram illustrating how the cloud synchronization button is not displayed in the state in which the cleanup folder is open on the document management screen.

FIG. 27 is a diagram illustrating an example of a query screen displayed by a synchronization processing section;

FIG. 28 is a diagram illustrating an example of a settings screen for the workspace that includes automatic synchronization settings;

FIG. 29 is a diagram illustrating an example of a procedure of a synchronization process;

FIG. 30 is a diagram illustrating an example of a batch synchronization screen;

FIG. 31 is a diagram illustrating an example of an action determination table for each state of mismatch; and

FIG. 32 is a diagram illustrating another example of a batch synchronization screen.

### DETAILED DESCRIPTION

<Overview of System>

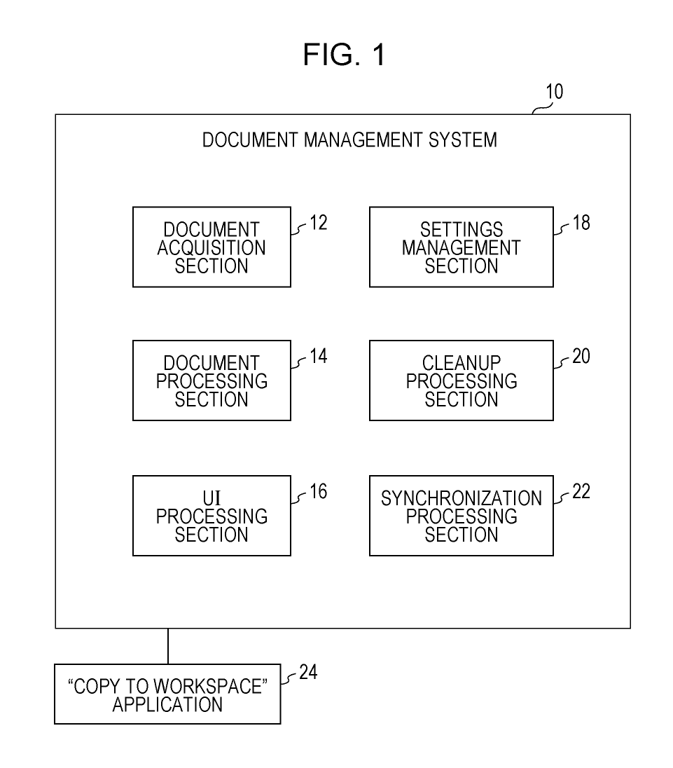

FIG. 1 illustrates an example of a schematic configuration of a document management system 10 according to the present invention. The document management system 10 is software that provides processing functions such as viewing, editing, annotating (adding highlighting, notes, stamps, and the like) with respect to registered document files, like DocuWorks (trademark) provided by the applicant, or Adobe Acrobat (trademark) by Adobe Systems, for example. This software realizes the functions of the document management system 10 by being executed on a computer such as a personal computer (PC) or a server. The document management system 10 may be a system for personal use installed on a PC, or may be constructed as a server that provides document handling services to remote users.

As functional modules, the document management system 10 includes a document acquisition section 12, a document processing section 14, a UI processing section 16, a settings management section 18, a cleanup processing section 20, and a synchronization processing section 22.

The document acquisition section 12 is in charge of a process for acquiring (that is, registering) documents (files) created externally to the document management system 10 into the document management system 10. The acquired documents may be files created by application software such as a word processor or a spreadsheet program in a data format unique to the application software (called application files), image files in an image data format such as bitmap, TIFF, or JPEG created by a device such as a scanner or digital camera, and the like. In addition, the documents acquired by the document management system 10 may also include video files, multimedia files, and the like. A document file acquired by the document acquisition section 12 is stored in one of the folders (for example, a folder specified by the user or a preset folder) under the management of the document management system 10. The document acquisition section 12 acquires an application file directly as a document file, or converts an application file into a document file stated in a specific data description language used by the document management system 10. The data description language used for conversion is a page description language (PDL), or some other type of language capable of describing the appearance of a document (image) similarly to a page description language (the PDF data format is one such example). Document files stated in the data description language may include multiple types of objects, such as text, vector graphics (figures stated in vector expression), and continuous-tone images (data formats such as bitmap, TIFF, and JPEG).

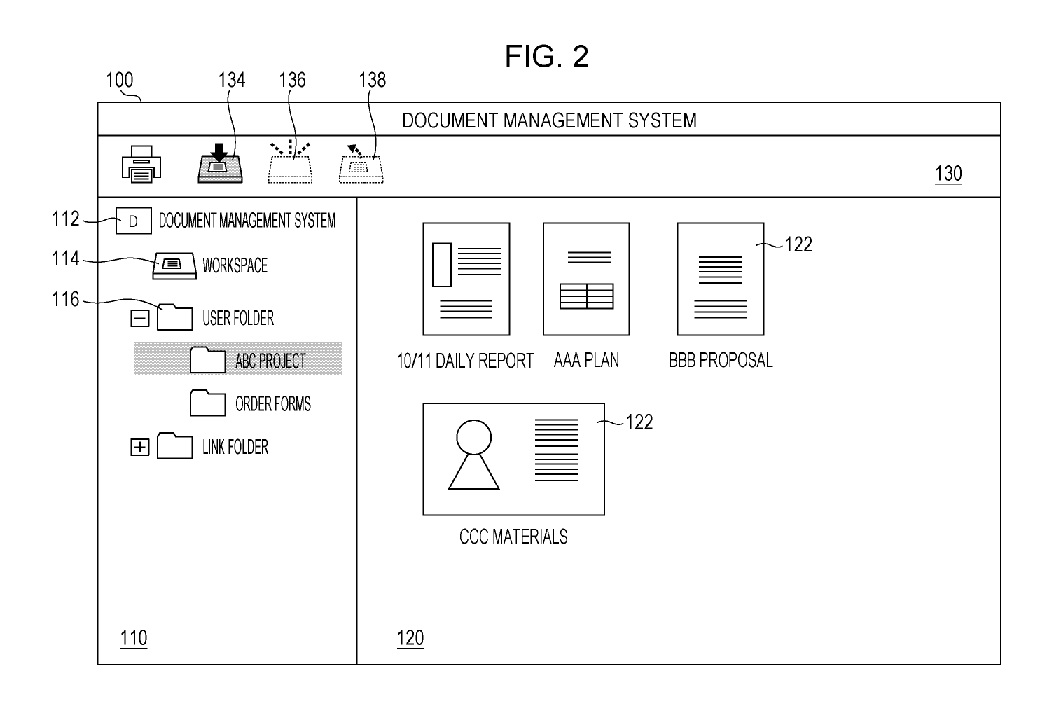

For example, if the user performs a drag and drop operation on the icon of a document inside a folder outside of the document management system 10 displayed on a graphical user interface (GUI) screen of a file system (for example, Explorer by Microsoft), and drops the document icon onto a folder icon or inside a document pane 120 on a GUI screen of the document management system 10 (see FIG. 2), the document acquisition section 12 converts the document into a document file in PDL or the like, and stores the converted document in the folder of the drop target. Additionally, the user may also call a virtual printer directed at the document management system 10 (the document acquisition section 12, or a separate program having similar functions) from an application, and output a document handled by the application to the virtual printer. The virtual printer converts the document into a document file in PDL or the like handled internally in the document management system 10, and saves the converted document in a specified folder inside the document management system 10.

Note that folders under the management of the document management system 10 (the workspace described later is one such example) are accessed from the document management system 10, and access from the file system of the OS is not assumed. To perform operations such as adding or deleting documents with respect to these folders, basically, the document management system 10 is started up. However, storing documents in the workspace or the like through the “Copy to workspace” application 24 described later is an exception, and the “Copy to workspace” application 24 has a function of storing documents in the workspace or the like when the document management system 10 has not been started up.

The document processing section 14 executes processes specified by the user on folders under the management of the document management system 10, and on document files inside the folders. For example, in the case in which the viewing of a document file is specified by the user, the document processing section 14 opens the document file, and displays images of the pages of the document file on the screen. Also, in response to instructions from the user, the document processing section 14 performs operations such as adding or deleting annotations with respect to the open document file. Also, the document processing section 14 has functions of “splitting” and “merging” documents. The splitting process refers to a process of dividing a single document file into a first document file containing a specified page and the pages before the specified page, and a second document file containing the pages after the specified page. Also, the merging process refers to a process of merging multiple document files specified by the user into a single document file. The merged document file becomes a file containing both the pages of a first document file and the pages of a second document file from before the merge. In addition, with regarding to a user folder 116 and child folders, the document processing section 14 receives an instruction from the user for creating child folders inside the folder.

The UI processing section 16 provides a user interface (UI) screen for operations on document files, and receives user operations with respect to the screen. For example, the UI processing section 16 generates and displays the document management screen 100 illustrated by example in FIG. 2 on the display device of a computer in which the document management system 10 is installed (the document management screen 100 will be described in detail later).

The document management screen 100 illustrated by example includes a folder pane 110, a document pane 120, and an operation button area 130.

The folder pane 110 is an area that displays a tree structure of folders under the management of the document management system 10. The root of the displayed tree is the document management system 10 itself (illustrated as the icon 112 in FIG. 2). In the example illustrated in the diagram, directly below the root, there are two folders called the user folder 116 and the link folder. The workspace 114 is a folder that stores documents for work currently in progress by a user. The workspace 114 will be described in further detail later. The user folder 116 is a folder used to organize and save documents used by the user of the document management system 10. Inside the user folder 116, lower folders, also called child folders and grandchild folders, may be created hierarchically. The user creates child folders as appropriate in accordance with a self-decided organizational structure, and stores documents in appropriate folders. The link folder is a link to a folder outside of the management of the document management system 10. When the link folder is “opened”, the child folders inside the folder of the link target is displayed in the folder pane 110.

In the document pane 120, icons 122 of document files inside the folder selected by the user inside the folder pane 110 are displayed as a list. In this example, the icons 122 of the document files are thumbnail images of the first page of each of the document files. By performing an “Open” operation, such as a click operation, on an icon 122, the document corresponding to the icon 122 is opened and the content is displayed on the screen, thereby enabling the user to perform editing operations (such as adding, deleting, or modifying, for example) on the content. As another example, if the user performs a drag and drop operation to move the icon of a certain document file on top of the icon of another document file, the user is able to issue an instruction to execute a merging process on the two document files. In addition, it is also possible to select processes to execute on a document file from a menu on the document management screen 100 omitted from the diagram, or from a context menu which is called by a mouse right-click operation on an icon. Note that a context menu refers to a screen in which selection options for processes with respect to an object (in this case, a document) corresponding to the menu are listed and displayed as menu items.

The operation button area 130 is an area that displays buttons 134 to 138 indicating various types of operations with respect to the folder displayed in the document pane 120 and the documents (icons 122) inside the folder. In the example illustrated in the diagram, in the operation button area 130, a print button that prints a document selected inside the document pane 120, a button 134 that gives an instruction to copy a document to the workspace (described later), a clean up button 136 that gives an instruction to temporarily clean up (described later) the workspace, a “source location” button 138 for opening the folder that is the copy source of a document inside the workspace, and the like are displayed.

Returning to the description of FIG. 1, the settings management section 18 receives the input of various setting items of the document management system 10, and stores the values of input setting items. Examples of setting items managed by the settings management section 18 include settings related to a folder to display in the document pane 120 of the document management screen 100 on startup of the document management system 10, synchronization of the workspace with a corresponding folder in a cloud system, and the like.

The cleanup processing section 20 executes a process of temporarily cleaning up the documents inside the workspace. The function of the cleanup processing section 20 will be described in detail later.

The synchronization processing section 22 executes a process for synchronizing the workspace with a corresponding folder in a cloud system. This process will be described in detail later.

The above thus describes an overview of the document management system 10. Next, various characteristics of the system will be described.

<Workspace>

As described above, the document management system 10 prepares the workspace 114, which is a folder for documents used in work that the user is currently engaged in. The workspace is a metaphor for the user's work area (a desktop, for example), and aims to allow the user to see the current overall work at a glance, or in other words, perspicuity of the work. This is in contrast to the hierarchical structure that includes the user folder 116 and the child folders inside, which aims to allow the user to organize the documents.

To ensure perspicuity of the work, only documents (files) are stored inside the workspace 114. In other words, the workspace 114 does not contain a hierarchical structure made of child folders. Hypothetically, if the workspace 114 were given an internal hierarchical structure of folders, it would be difficult to present a list of all documents currently being used in the work, arranged on a single document pane 120. In this case, grasping the entirety of the workspace 114 may involve operations of moving among the hierarchy. In contrast, since the workspace 114 has a flat structure made of documents only, the user does not have to go back and forth among the hierarchy, and icons (such as thumbnails) of all documents may be listed on the document pane 120.

The workspace 114 is used as a temporary work area, whereas documents are stored by being organized into the hierarchical folders inside the user folder 116.

<Registration of Document in Workspace>

The registration (saving) of a document in the workspace 114 is realized by performing a “Copy to workspace 114” operation on a document in an existing folder.

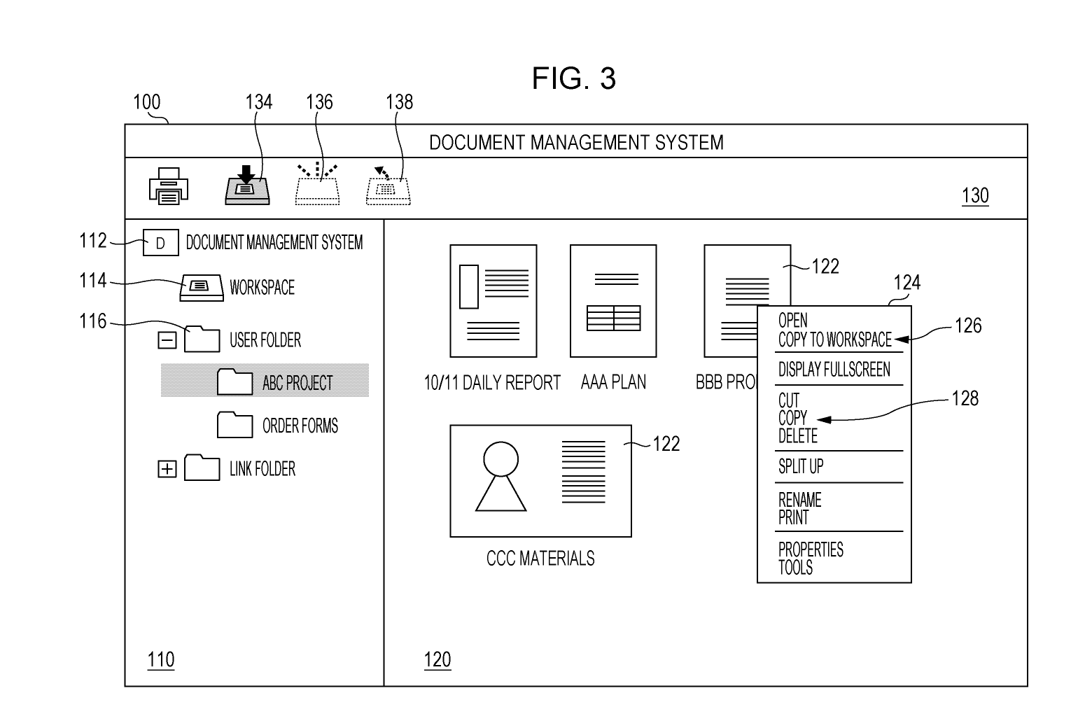

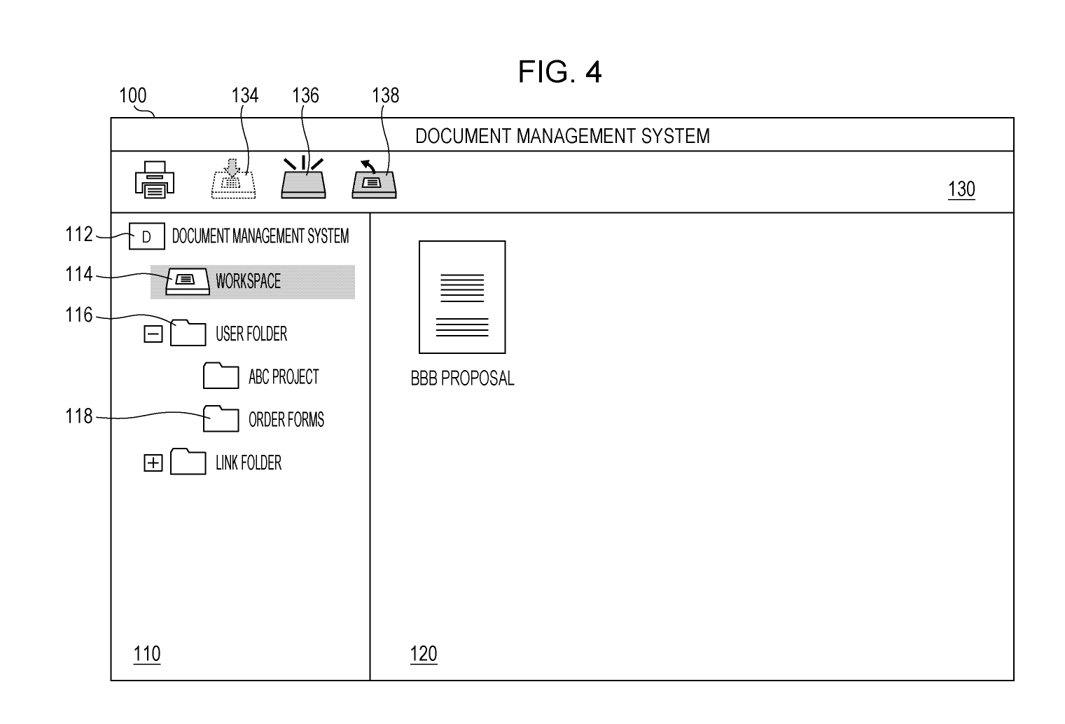

On the document management screen 100 illustrated by example in FIG. 3, the icons 122 of documents inside a certain folder (folder name: “ABC Project”) in the user folder 116 of the document management system 10 are listed and displayed on the document pane 120. Subsequently, by performing a specification operation, such as a mouse right-click, on one of the documents (name: “BBB Proposal”), a context menu 124 is called with respect to the document. The context menu 124 includes general operation items such as “Open” (open the document and display the contents), “Cut”, “Copy” 128, “Delete”, “Rename”, and “Print”, as well as an operation item called “Copy to workspace” 126. If the user performs a click operation or the like to give an instruction to execute “Copy to workspace” 126, the document processing section 14 creates a copy of the document (file), and saves the copy inside the workspace 114. After this operation, when the workspace 114 is opened, an icon of the document is displayed inside the workspace 114 in the document pane 120, as illustrated in FIG. 4.

Hypothetically, if the general “Copy” 128 operation item of the related art is selected, the document is only stored in the clipboard (a temporary storage area for copied (or cut) data, made available by the OS). Consequently, copying a document to the workspace 114 would involve executing the “Copy” 128 first, and then additionally executing a “Paste” operation to paste the copy of the document in the clipboard to the workspace 114. In this way, in the case of using the operation item “Copy” 128 of the related art, the user performs a total of at least two operations, namely a copy operation and a paste operation.

In contrast, in the case of the operation item “Copy to workspace” 126, the user is able to copy a target document to the workspace 114 with one touch, or in other words with a single operation of selecting the operation item.

Additionally, it is also possible execute an operation similar to “Copy to workspace” 126 by pressing a “Copy to workspace” button 134 inside the operation button area 130 after selecting a document inside the document pane 120.

Also, for each of the data formats acquirable by the document management system 10, a “Copy to workspace” menu item may be added to the context menu corresponding to the data format which is managed by the OS. The menu item is associated with the “Copy to workspace” application 24 installed on the same computer as the document management system 10. The application 24 may be read out even when the document management system 10 has not started up. If the user calls the context menu from a document icon displayed on a GUI screen of the file system of the OS, and selects and executes the “Copy to workspace” item on the menu, the OS launches the “Copy to workspace” application 24, and passes the path name of the document. The launched “Copy to workspace” application 24 creates a copy of the document indicated by the path name, and saves the copy in the workspace. Note that in the case in which the data format of the document is different from the internal data format of the document management system 10 (such as PDL format), the copy may be saved to the workspace after first changing data format of the copy to the internal data format. With this arrangement, it becomes possible to copy documents to the workspace with a single operation similar to the above, even for a document not under the management of the document management system 10 (that is, a document inside a folder that does not belong to the folder tree whose root is the document management system 10).

In addition, it may also be configured so that a document being displayed by an application that creates or edits documents, such as a word processor, may be registered in the workspace from the UI of the application. This may be achieved by, for example, registering “Document management system workspace” as a selection option for the print destination in the print instruction UI of the application, and associating the selection option with a virtual printer that executes a process similar to the “Copy to workspace” application 24. When the user wants to register a document being displayed by the application such as a word processor in the workspace, it is sufficient for the user to call the print instruction screen of the application, select “Document management system workspace” as the print destination, and issue an instruction to execute printing.

Also, although the above examples illustrate UI elements such as a context menu and a Copy button to use when registering a document in the workspace, it may also be configured so that a document may be registered by a similar UI element with respect to a folder other than the workspace inside the document management system 10. In this case, it may be configured so that the settings management section 18 is able to set or change the copy destination folder to associate with the operation item “Copy to workspace” 126 of the context menu or the “Copy to workspace” button 134 inside the operation button area 130. In this case, the “workspace” character string inside the operation item “Copy to workspace” 126 of the context menu may also be changed to the name of the set copy destination folder.

The above illustrates an example of a case of copying a document in a folder outside the workspace to the workspace, but a document may also be registered in the workspace by a registration method other than copying, such as moving (in this case, the document is deleted from the source folder), for example.

<Mechanisms for not Creating Hierarchical Folder Structure Inside Workspace>

As described above, the workspace does not have a hierarchical structure. Mechanisms for maintaining a workspace without a hierarchical structure are described below.

For example, in the case of using a folder created inside the file system used by the operating system (OS) as the workspace 114, in order not to create a hierarchical structure in the workspace 114, the document processing section 14 does not accept user instructions to create child folders with respect to the workspace 114. For example, on the context menu called by a specific operation (for example, a mouse right-click) on an icon of the workspace 114 inside the folder pane 110, a menu item for giving an instruction to create a new folder is not displayed. Also, when the workspace is open in the document pane 120, an item for creating a new folder is not displayed in a context menu called from the workspace (in the space other than document icons).

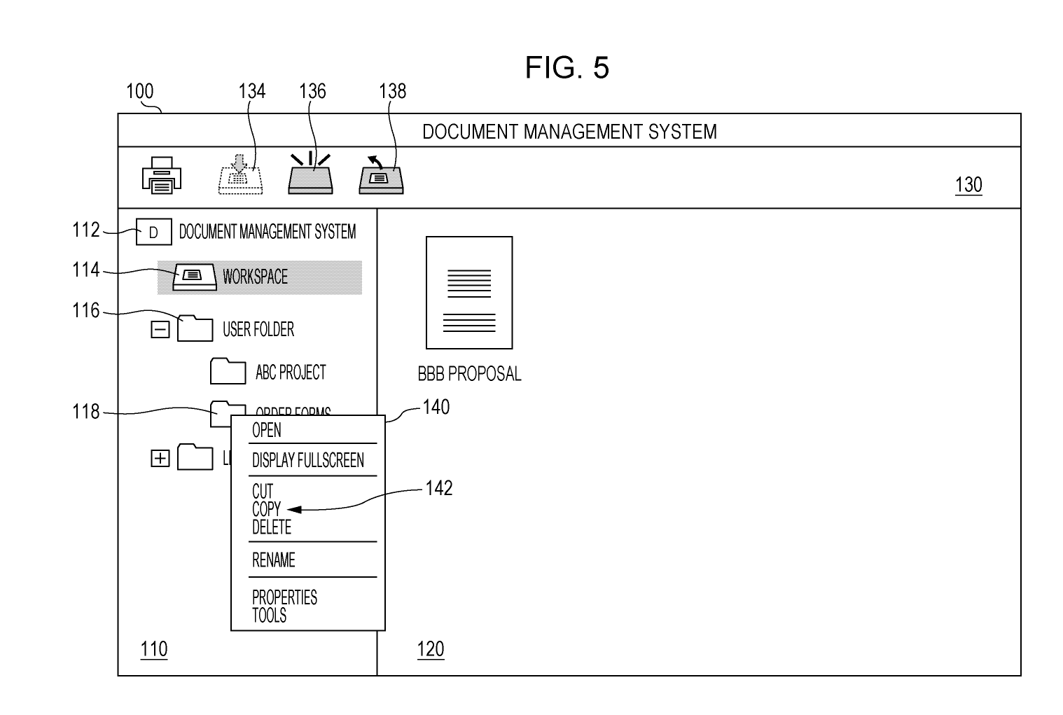

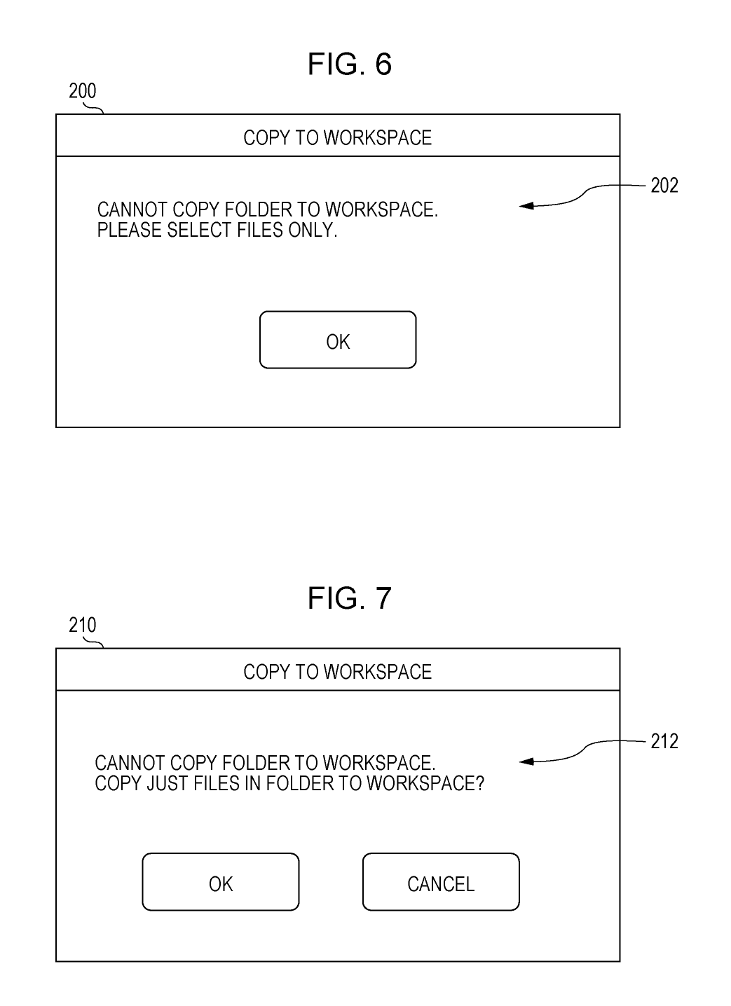

Also, as illustrated by example in FIG. 5, a “Copy to workspace” item is not included in a context menu 140 called by an operation, such as a mouse right-click, from a folder inside the folder pane 110. With this arrangement, folders are not copied to the workspace by a one-touch operation. A “Copy” 142 item is included in the context menu 140, but the process which is executed when this item is selected by the user is a process that copies the folder (which may include documents and child folders inside the folder) to the clipboard. Hypothetically, even if an operation of pasting a copied folder from the clipboard to the workspace is performed, if it is detected that the object one is attempting to paste into the workspace is a folder, in one example, the document processing section 14 prohibits the past. At this time, the document processing section 14 displays an error notification screen 200 illustrated by example in FIG. 6 through the UI processing section 16. On the error notification screen 200, there is displayed an error message 202 indicating that copying a folder to the workspace is prohibited.

Similarly, the context menu for a folder not under the management of the document management system 10 does not include a menu item that calls the “Copy to workspace” application 24. Also, even if one attempts to copy such a folder to the workspace through the clipboard, the document processing section 14 detects that the copying of a folder is being attempted, and prohibits the copy.

In addition, even if one attempts to copy or move a folder outside the workspace into the workspace open in the document pane 120 by a drag and drop operation, the document processing section 14 managing the workspace prohibits the operation. In other words, if the document processing section 14 detects that the object one is attempting to save in the workspace via the operation is a folder, the document processing section 14 prohibits the save, and displays the error notification screen 200 (FIG. 6) described earlier, for example.

In the above, a hierarchical structure inside the workspace is avoided by prohibiting the copying of folders to the workspace. As another example, in the case in which the user performs an operation of copying a folder to the workspace, the document processing section 14 may read out and copy documents inside the folder to the workspace. Herein, the document to copy to the workspace may be limited to those which are included directly in the folder, or may be all documents included in the folder and child folders. In either case, the folder itself selected as the copy target, as well as the child folders inside the folder, are not copied to the workspace, and instead only documents are copied into the workspace.

If an operation of copying a folder to the workspace is received from the user, the document processing section 14 may display, through the UI processing section 16, a query screen 210 displaying a query message 212 asking whether or not to copy only the documents (files) inside the folder, as illustrated by example in FIG. 7. If the user presses an OK button on the query screen 210, the document processing section 14 creates a copy of each document inside the folder, and after converting these copies to the data format of the document management system 10, saves (pastes) the copies in the workspace. In the case in which the user presses a Cancel button, the document processing section 14 cancels the process of copying the folder to the workspace.

Also, the user may be enabled to configure a setting with respect to the settings management section 18 so that, in the case in which the user performs an operation of copying a folder to the workspace, the error notification screen 200 (“Folder copying is prohibited”) is displayed without executing the copy, or only the documents inside the folder are copied (“Copy documents inside folder”). Also, for the case of copying only the documents inside the folder, it may be configured in the settings management section 18 whether to copy only the documents included directly in the folder, or to copy all documents included in the folder and child folders. Also, the display of the context menu may be controlled so that, in the case in which “Copy documents inside folder” described above is set in the settings management section 18, the item “Copy to workspace” is displayed in the context menu that opens with respect to the folder, whereas in the case in which “Folder copying is prohibited” is set, the item “Copy to workspace” is not displayed.

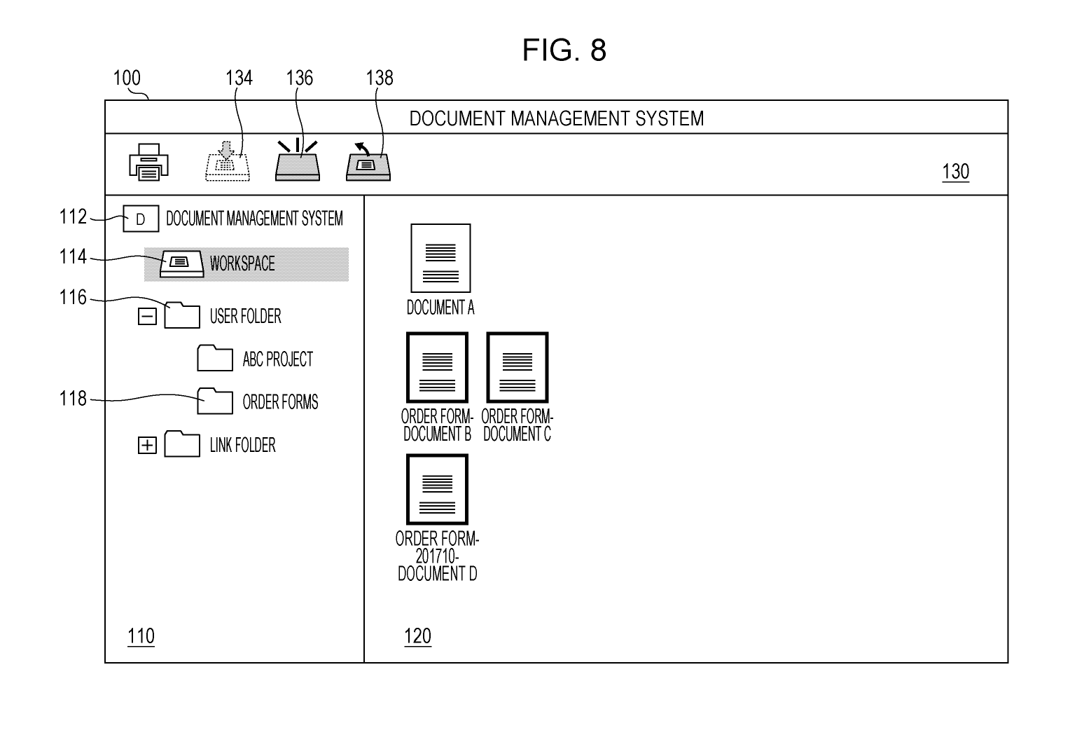

Also, in the case of reading and copying documents inside a folder to the workspace in response to a user instruction to copy the folder to the workspace, the document processing section 14 may present a display indicating that the copied documents originates from the same folder in the workspace displayed in the document pane 120 of the document management screen 100. FIG. 8 illustrates such an exemplary display. The example in FIG. 8 is an example of the case of copying an order forms folder 118 to the workspace in which a document A has already been saved. In the document pane 120, the icons of documents B, C, and D newly added to the workspace are displayed with greater emphasis than the icon of the preexisting document A (in other words, a display mode that is easy to notice; in the illustrated example, the icon outlines are emphasized). Also, the icons of the documents B, C, and D have a common display mode (for example, the outlines are the same color), thereby expressing that these three documents have been copied from the same folder. Also, the icons of the three documents are displayed along with filenames expressing the path name of each document from the order forms folder. In the illustrated example, for example, whereas the document B is a file included directly in the order forms folder, the document D is a file included in a folder named “201710” under the order forms folder. Also, in the display in FIG. 8, the icon of the document D is displayed below the icons of the documents B and C, thereby expressing that the document D belongs to a lower-level folder than the documents B and C.

<Display on Startup>

Next, the display of the document management screen 100 displayed on startup of the document management system 10 will be described.

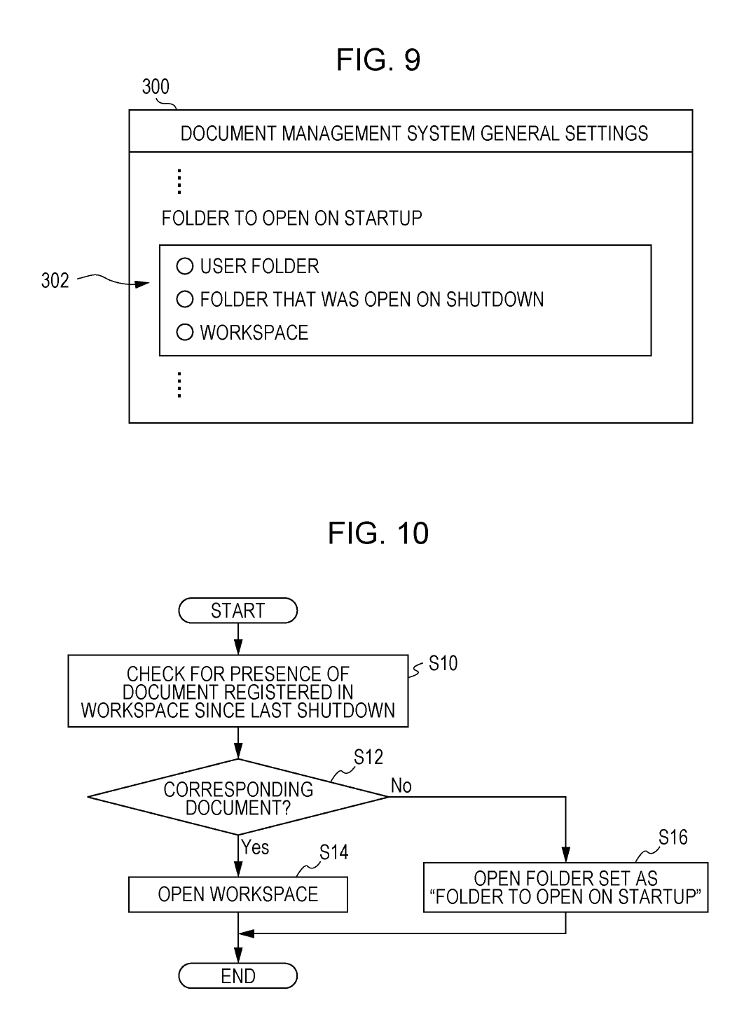

In the settings management section 18, a folder to open in the document pane 120 of the document management screen 100 immediately after startup may be set. A settings screen 300 that receives the setting for the folder to open on startup is illustrated by example in FIG. 9. In this example, in a selection options field 302, the folder to open on startup may be selected from among the three selection options of the user folder, the folder that was open when the document management system 10 shut down previously, and the workspace. In ordinary cases other than an exception case to be described next, the document management system 10 decides the folder to open in the document pane 120 on startup by following this setting.

On the other hand, the exceptional case described above is the case in which a document is registered in the workspace while the document management system 10 is shut down (that is, the period in which the document management system 10 is in an inactive state). As described above, in the present exemplary embodiment, even while the document management system 10 is shut down, documents may be registered in the workspace by calling the “Copy to workspace” application 24 from the context menu of a document in the file system UI, by issuing an instruction to print to a virtual printer that treats the workspace as the print destination from an application that creates and edits documents, such as a word processor, and the like. In this way, in the case in which a document is registered in the workspace while the document management system 10 is shut down, there is a high probability that the user intends to perform work in the workspace using the document. However, in the case in which the setting for the folder to open on startup is a folder other than the workspace, the folder which is opened immediately after the startup of the document management system 10 is not the workspace. Consequently, confirming the document newly registered in the workspace involves performing an operation of opening the workspace.

Accordingly, in the present exemplary embodiment, in the case in which a document is registered in the workspace while the document management system 10 is shut down (that is, the period in which the document management system 10 is not being executed, or in other words is not running), the workspace is opened in the document pane 120 on startup of the document management system 10, irrespectively of the setting for the folder to open on startup. An example of a display control procedure on startup is illustrated in FIG. 10.

In the procedure of FIG. 10, when the document management system 10 is started up, first, the UI processing section 16 checks for the presence of a document registered in the workspace after the previous shutdown of the document management system 10 (S10). The check in S10 is executed by, for example, querying a program having the function of registering documents in the workspace while the document management system 10 is shut down (for example, the “Copy to workspace” application 24 and the virtual printer) about whether or not a document has been registered during the shutdown period. The program (that is, the virtual processing device realized by causing a computer to execute the program) records a log including information about the times when documents are registered in the workspace, and in response to the query from the UI processing section 16, returns the time when a document was last registered in the workspace. If the time returned from the program is between the last shutdown time of the document management system 10 (this time is recorded by the document management system 10) and the current time, the UI processing section 16 determines that a document has been registered in the workspace while the document management system 10 is shut down. Conversely, the UI processing section 16 may also transmit a query including the last shutdown time of the document management system 10 to the program, and the program may respond to indicate whether or not a document has been registered since the shutdown time. Also, instead of issuing a query to the application, the UI processing section 16 may also make the determination by referencing the log recorded by the program. Alternatively, when a document is stored (copied or the like) in the workspace, the program sets a flag to a value indicating “stored”, and during the startup of the document management system 10, the UI processing section 16 may reference the flag to determine the presence of a document stored in the workspace while the document management system 10 was inactive, and then reset the flag. As yet another example, the document management system 10 may store a list of documents inside the workspace at the time of the last shutdown, and by cross-referencing this list with the documents in the workspace at the current startup time, the document management system 10 may determine the presence of a document newly added to the workspace during the shutdown period.

In the check of S10, in the case of determining that a document has been added to the workspace while the document management system 10 is shut down (S12), the UI processing section 16 displays the document management screen 100 displaying the documents inside the workspace in the document pane 120 (S14). On the other hand, in the case of determining in S10 that a document has not been added to the workspace while the document management system 10 is shutdown, the UI processing section 16 displays the document management screen 100 in which the folder corresponding to the “Folder to open on startup” setting in the settings management section 18 is open in the document pane 120 (S16).

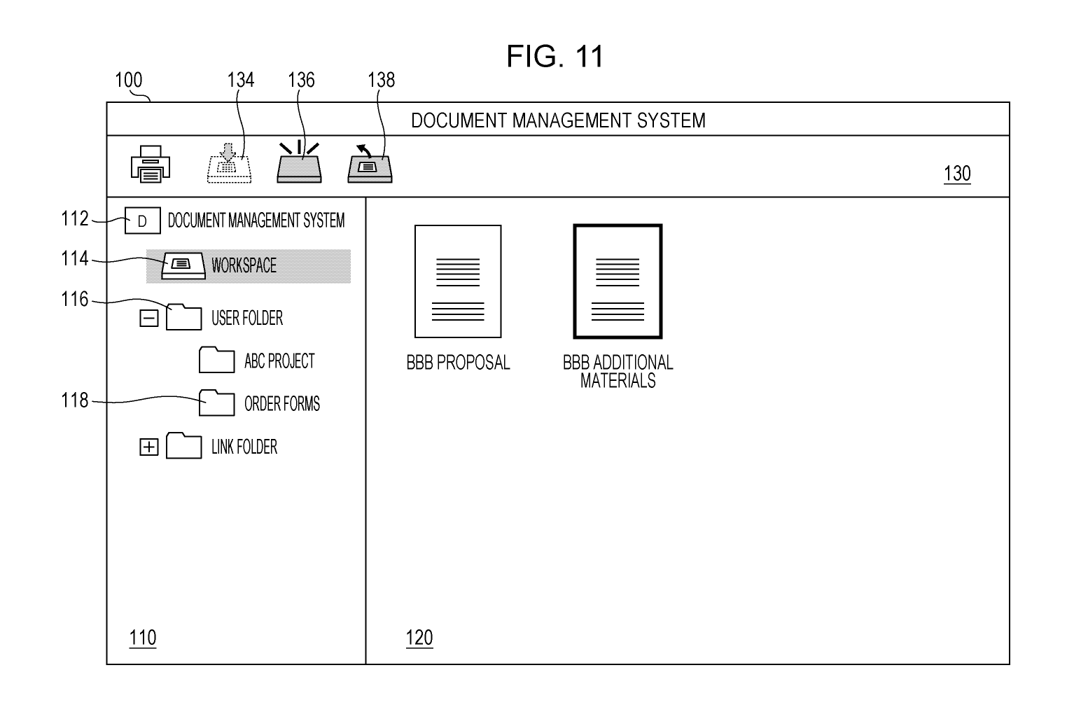

FIG. 11 illustrates an example of the document management screen 100 displaying the documents inside the workspace in the document pane 120, which is displayed by the process of S14 on startup of the document management system 10. This example is the document management screen 100 displayed on startup of the document management system 10 after a document named “BBB additional materials” is newly registered while the document management system 10 is shutdown, with respect to a workspace in which only a document named “BBB proposal” existed on the previous shutdown of the document management system 10. In this example, the icon of the document “BBB additional materials” newly registered in the document pane 120 is displayed in a display mode that is different from the icon of the preexisting document “BBB proposal”. In particular, the icon of the newly registered document is displayed in a display mode that is more noticeable than the icon of the preexisting document.

Also, like the document management screen 100 in FIG. 8 described earlier, the document management screen 100 that opens on startup may also reflect information about the copy source folder of each document that is registered in the workspace while the document management system 10 is shut down. In other words, in the example of FIG. 8, the icon of each document newly registered in the workspace is displayed along with a filename including information about the path of the copy source document of the corresponding document. Also, the icons of each of the documents are arranged top-to-bottom to express the hierarchy of the folder to which the newly registered documents belong.

Note that in the procedure of FIG. 10, in the case in which a document is registered in the workspace while the document management system 10 is shut down, the workspace is opened on the document management screen 100 when the document management system 10 starts up again later, but this is merely one example. Instead, the user may also configure a setting in the settings management section 18 regarding whether to treat the workspace as the folder to open in the document management screen 100 on startup of the document management system 10 after a document is registered in the workspace while the document management system 10 is shut down, or to follow the setting for the folder to open on startup.

The above example describes operations on startup of the document management system 10 in the case in which a document has been registered in the workspace while the document management system 10 is shut down, but similar operations may also be executed for a folder other than the workspace. In this case, the folder on which to execute the operations is set by the user in the settings management section 18. On startup, if the document management system 10 ascertains that a document has been added to the folder while the document management system 10 was shut down, the folder is opened in the document pane 120 of the displayed document management screen 100.

<Display of Source Location of Document in Workspace>

The workspace is a virtual work area in which the user is anticipated to copy documents saved in folders with a hierarchical structure for organization, for example, and perform work in the workspace using the copied documents. During such work, the user may desire information about the copy source location (folder) of a document inside the workspace. For example, consider a case of doing the work of correcting a document while comparing the document against a model document, in which the current model document is copied to the workspace from a folder containing model documents, and the current document being worked on is copied to the workspace from a folder containing documents to correct. In this case, when the user is judging whether each document in the workspace is the model document or the document to correct, it is useful to know information about the copy source location of each of these documents. Also, in some cases, it may be desirable to refer to another document inside the copy source folder of a document in the workspace.

Accordingly, the document management system 10 adds information about the save location of the copy source document as an attribute to the document copied to the workspace. In other words, when a processing section having a function of copying documents to the workspace (for example, the document processing section 14 that registers documents in the workspace while the document management system 10 is running, or the “Copy to workspace” application 24 which is capable of registering documents in the workspace while the document management system 10 is shut down) copies a document inside a certain folder to the workspace, the path name of the copy source document is added to the attribute information of the copied document as an attribute item named “Source location”, for example. With this arrangement, processing that uses the “Source location” attribute with respect to documents in the workspace becomes possible.

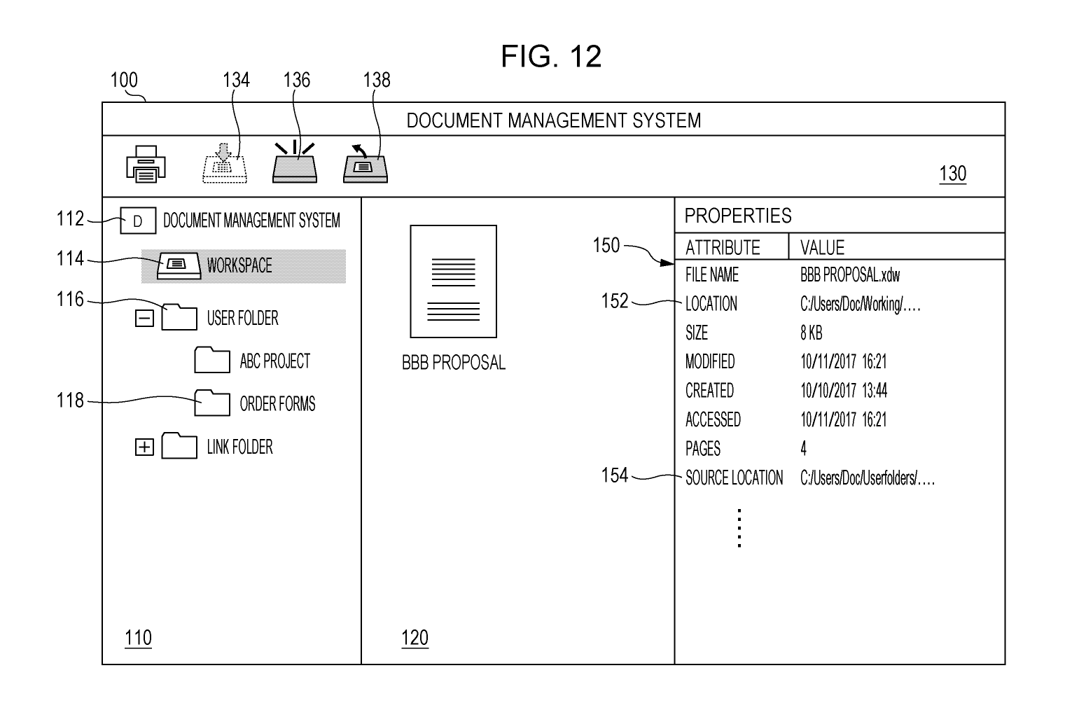

For example, in the case of receiving an instruction to display the attribute information of a document selected by the user in the workspace open in the document pane 120, the UI processing section 16 displays an information view 150 indicating the attribute information, as illustrated by example in FIG. 12. In the information view 150, besides a “Location” 152 where the document is stored (for example, the path name of the document), the value of a “Source location” 154 of the document is displayed.

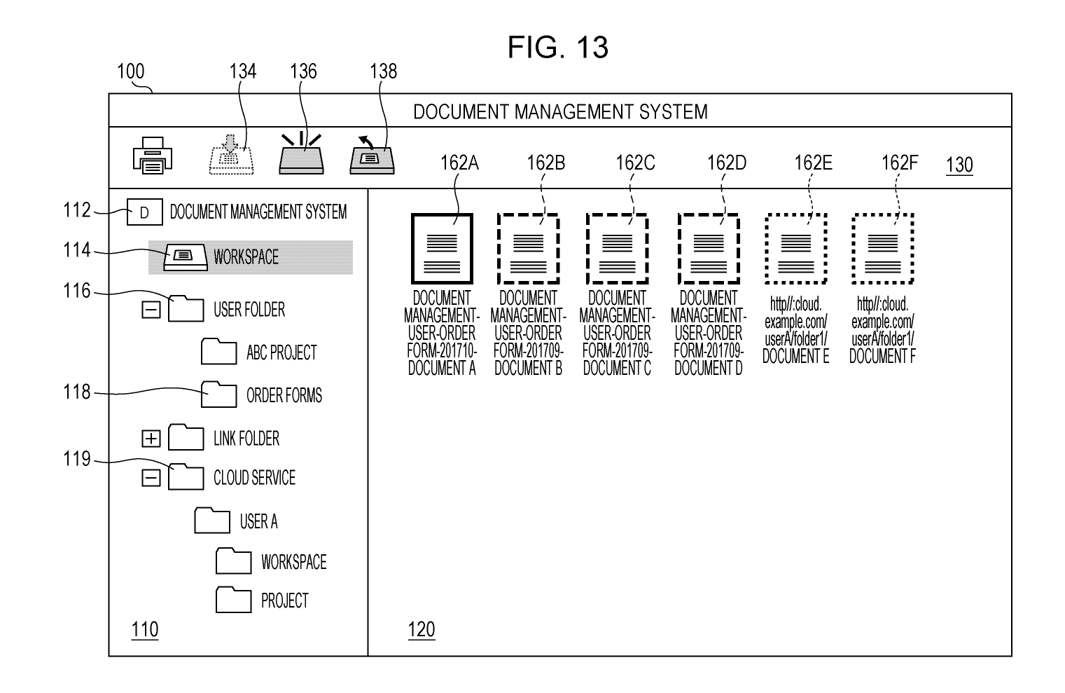

Additionally, the UI processing section 16 may also present a display reflecting the “Source location” of each document in the workspace open in the document pane 120. FIG. 13 illustrates one such example. In this example, the display modes of icons 162A to 162F for each of the documents in the workspace open in the document pane 120 are distinguished by each “Source location”. For example, since documents B, C, and D have the same “Source location” folder, the display mode of the icons 162B, 162C, and 162D of these three icons (such as the color of the icon and the icon outline, line thickness, and brightness, for example) is the same, and the display mode is different from the display mode of the icon 162A of the document A and the icons 162E and 162F of the documents E and F which have different “Source location” folders.

Also, in the example of FIG. 13, the icon of each document is displayed along with a filename that reflects the “Source location” of the document. For example, the document A is a copy from one of monthly subfolders in the order forms folder inside the user folder under the management of the document management system 10, and the filename display for the icon 162A of the document A is a character string expressing the path from the document management system 10 (“Document Management”) to the document A (copy source) inside the monthly subfolder. Also, although omitted from illustration, for a document copied to the workspace from another local folder not under the management of the document management system 10, the filename display is a character string expressing the full path of the copy source of the document.

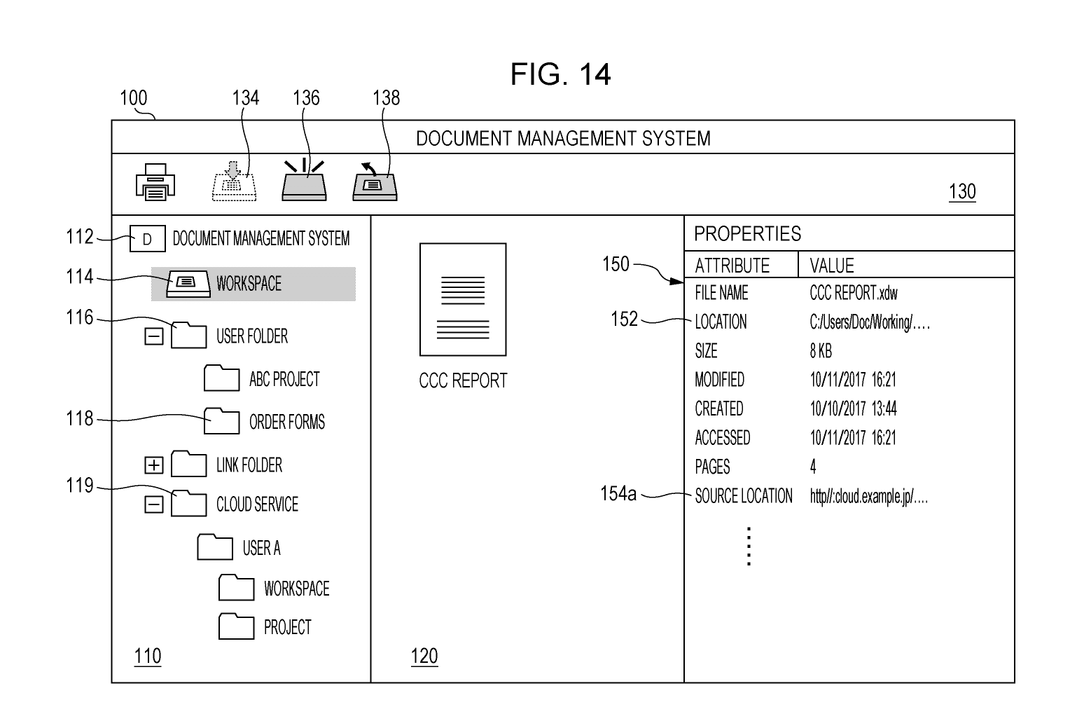

In addition, files on a remote server external to the computer in which the document management system 10 is installed may also be copied to the workspace. The document management screen 100 illustrated by example in FIG. 13 indicates a state in which a cloud service 119 having a function of storing documents on the Internet is mounted and used in the document management system 10. The icons 162E and 162F represent copies of documents E and F which exist in a folder in the cloud service 119. Herein, although the documents E and F themselves exist as temporary files on the computer, the icons 162E and 162F are displayed along with a filename display expressing the Uniform Resource Locator (URL) of the copy source of the documents E and F so that the user is unaware of the temporary files on the computer. Note that in the case of displaying the information view 150 similar to FIG. 12 for the documents E and F, the URL is displayed in the Source location 154a field, as illustrated in FIG. 14.

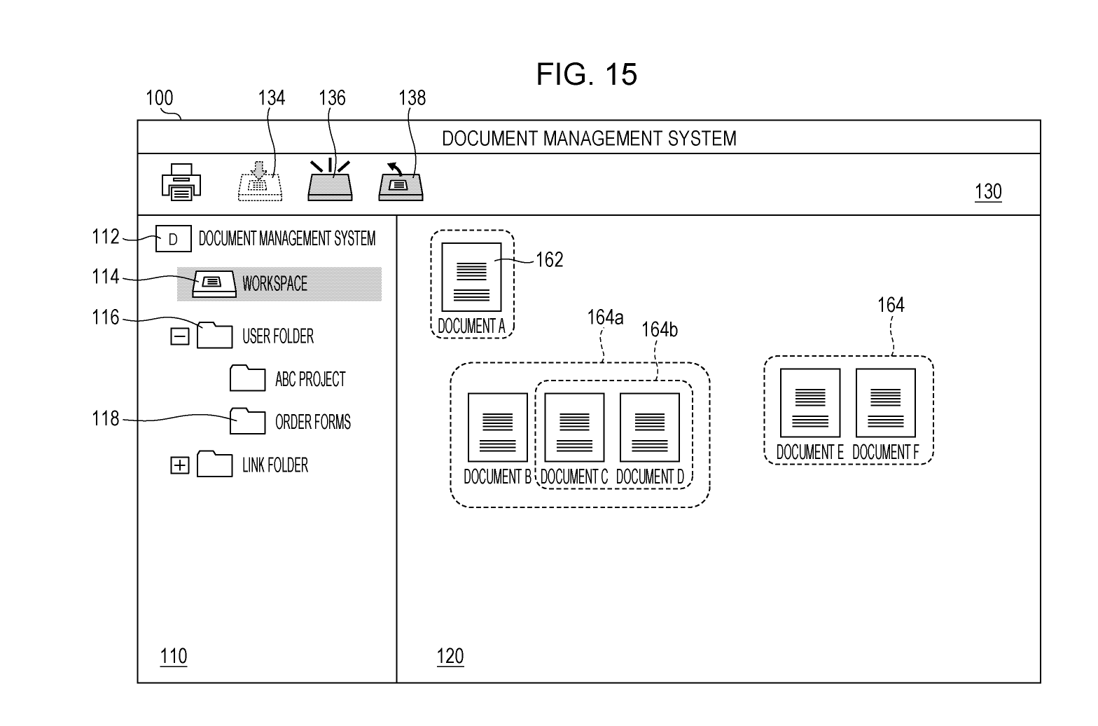

In addition, as illustrated in FIG. 15, the UI processing section 16 may also display the icons of documents in the workspace open in the document pane 120 so that documents with the same copy source folder are grouped together. In the example illustrated in the diagram, the icons 162 of documents with the same copy source folder are arranged in areas enclosed by frames 164 for grouping. Also, in the example illustrated in the diagram, the hierarchy of the folders to which each of the documents belongs is expressed by a nested structure of the frames 164. For example, the display in FIG. 15 expresses that the document B is saved in a folder a represented by the frame 164a, while the documents C and D are saved in a separate folder b (represented by the frame 164b) under the folder a.

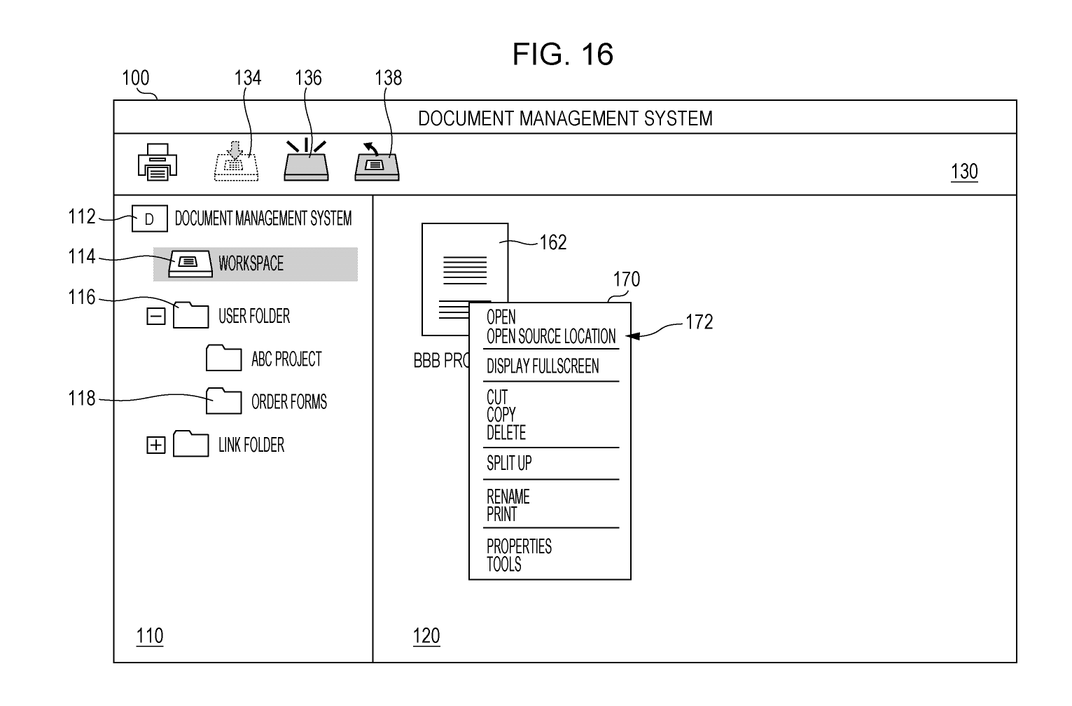

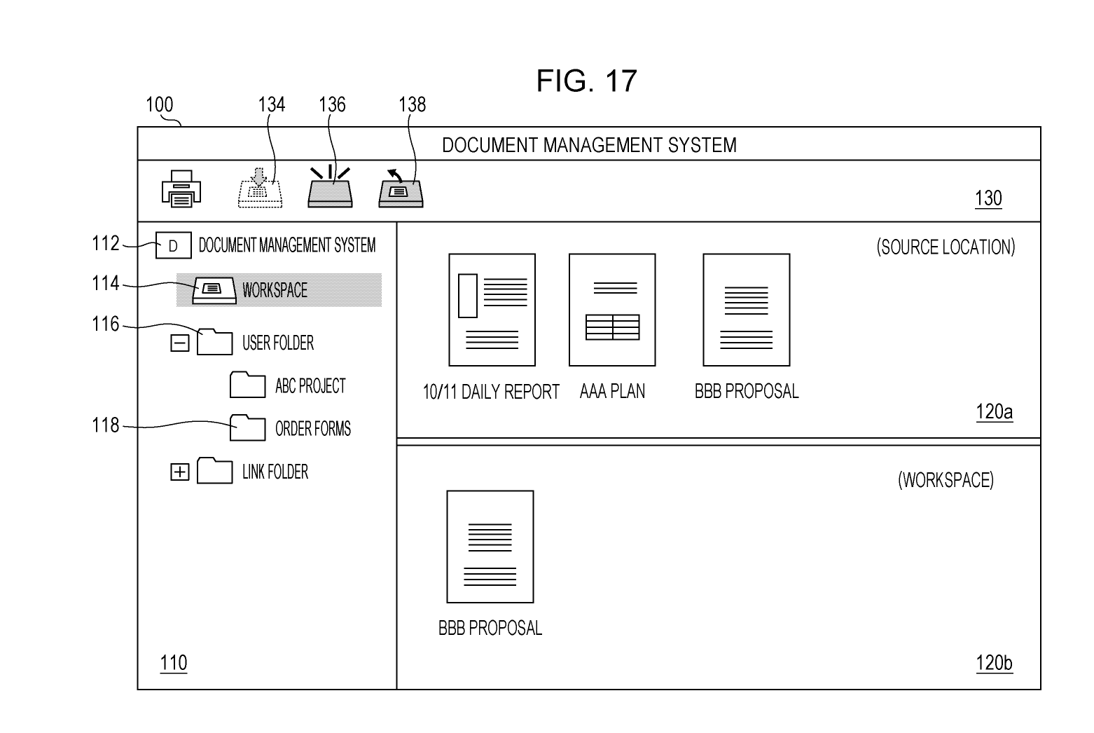

Also, the UI processing section 16 has a function of opening the “Source location” folder of a document in the workspace, and displaying the documents in the folder. For example, FIG. 16 illustrates a state in which, in the workspace open in the document pane 120, the user moves a cursor over the icon 162 of a certain document (in other words, selects the document), and causes a context menu 170 to be displayed by a mouse right-click operation or the like. The context menu 170 includes a menu item 172 labeled “Open source location”. If the user selects this menu item, the UI processing section 16 displays icons of the documents inside the “Source location” of the document (the folder in which the copy source of the document is saved), as illustrated by example in FIG. 17. In the example of FIG. 17, the document pane 120 is bisected into top and bottom panes, in which the workspace is displayed in the bottom pane 120b, and the “Source location” is displayed in the top pane 120a. In the example illustrated in the diagram, the icons of three documents saved in the “Source location” are displayed in the pane 120a. The user is able to open and view the documents in the pane 120a, and also copy a document inside the pane 120a to the bottom pane 120b (the workspace) with a drag and drop operation. Also, while the “Source location” is open, among the documents inside the workspace in the bottom pane 120b, the icon of the document corresponding to the “Source location” (in other words, the document selected as the target for which to open the “Source location”) may be displayed in a display mode distinguishable from the icons of other documents inside the workspace (for example, an emphasized display achieved by changing the color, brightness, or the like). With this arrangement, the user is informed which document in the workspace corresponds to the opened “Source location”.

Also, among the documents in the “Source location” in the document pane 120a, the icon of the document with the same name as the document in the bottom document pane 120b corresponding to the “Source location” (that is, the icon of the copy source document) may be displayed in a display mode distinguishable from the icons of other documents inside the “Source location”.

Also, in the case of opening the “Source location” in the top pane 120a from a context menu 170 or the like for a certain document in the workspace, the icons of documents in the workspace (bottom pane 120b) having the folder of the “Source location” now open in the pane 120a as the “Source location” attribute may be displayed in a display mode distinguishable from the icons whose “Source location” attribute is any other value. With this arrangement, the user is able to grasp which documents in the workspace (bottom pane 120b) have the same “Source location” as the document selected as the focus target inside the workspace. If the user is able to grasp which documents in the workspace come from the same “Source location” as the document that the user is focused on, such documents may serve as a reference in the work by the user.

Also, in the case of displaying the icons of documents having the same “Source location” attribute as the document selected by the user in a display mode distinguishable from other documents in the workspace in this way, the icon of the document in the workspace on which the operation of opening the “Source location” is first performed, and the icon of the documents in the workspace having the “Source location” as an attribute, may be displayed in display modes which are distinguishable from each other in the bottom pane 120b. In other words, in this example, the icon of the document in the workspace on which the operation of opening the “Source location” is first performed is displayed differently from the icons of the other documents having the same “Source location”. With this arrangement, the user is able to distinguish the document originally focused on (the target of the operation of opening the “Source location”) from other documents (particularly other documents sharing the same “Source location”). A series of work operations performed by opening the “Source location” is considered to be positioned as sub-work operations performed by interrupting the original work operations in many cases. By marking the document on which the opening operation is (first) performed to be distinguishable from other documents like in this example, it is possible to provide guidance enabling the user to return smoothly to the original work operations.

For example, while the user is carrying out work using a document inside the workspace, the user uses the function of opening the “Source location” to refer to other documents in the “Source location” of the work document, or to use the other documents in the work. Also, by performing an “Open” operation such as by clicking on the icon of a document displayed in the top pane 120a, a document in the “Source location” may be opened, and the contents may be displayed.

Also, in the case in which the “Source location” is a folder not under the management of the document management system 10, the document management system 10 may also call the file system UI of the OS (for example, Windows (registered trademark) Explorer (trademark)), and open the folder of the “Source location” on the screen of the UI. Obviously, even in this case, the “Source location” may also be opened in a pane or window created inside the document management screen 100, similarly to the example of FIG. 17.

Also, even in the case in which the “Source location” is inside a remote computer connected to the document management system 10 over a network, the document management system 10 similarly acquires and displays information about the “Source location” folder on the screen.

Note that the button 138 inside the operation button area 130 is a button for calling the operation of opening the “Source location”. The user, by pressing the button 138 and selecting a target document from inside the workspace, is able to open the “Source location” folder of the document on the screen, similarly to the above-described.

In addition, the UI processing section 16 receives an instruction to write back a document inside the workspace to the “Source location”. Write-back may be a process of overwriting the document of the same name in the “Source location”, or a process of writing the document to the “Source location” with a new name. The UI processing section 16 displays menu items such as “Save in source location” and “Save as . . . in source location”, for example, in the context menu called from the icon of a document inside the workspace displayed in the document pane 120 or the folder pane 110 of the document management screen 100. If the former item is selected, the document overwrites the document of the same name in the “Source location”, whereas if the latter item is selected, input of the name of the document is received, and the document is saved in the “Source location” with the input name.

In the above example, the path name of the copy source document of a document in the workspace is recorded as the “Source location” attribute of the document in the workspace, but instead of the entire path name, the path name minus the document name at the end (that is, the path of the folder containing the copy source document) may also be treated as the “Source location” attribute. Even in this case, if a service does not demand specification down to the copy source document, the service may be provided.

In the above example, information about the source location is recorded for a document registered in the workspace from another folder, and various types of services are provided according to the information. However, folders other than the workspace may also be handled similarly. In this case, the folder which is treated as the target of the “Source location” services is set by the user in the settings management section 18. In the case in which a document from another folder is registered in the folder indicated by the setting, the document management system 10 records information about the “Source location” as an attribute of the document.

<Temporary Cleanup of Workspace>

A case is conceivable in which, while the user is carrying out work using the workspace, it becomes desirable to execute different work of higher priority in the document management system 10. In this case, if the user could free up the workspace by temporarily cleaning up (evacuating) the documents for the current work in the workspace to some location, and place the documents for the new work in the free workspace, the work efficiency would be favorable. Also, after the interrupting work is completed, it would be convenient if the user could move the previously cleaned-up documents back to the workspace and resume the interrupted work. In the following, such a temporary work cleanup function included in the document management system 10 will be described.

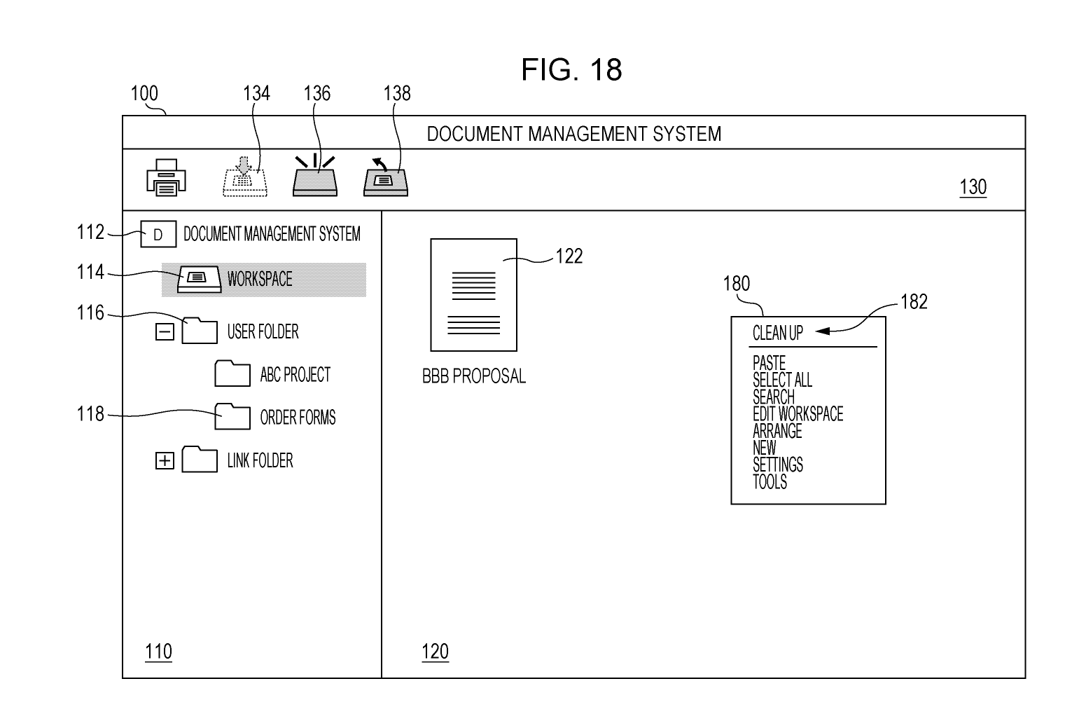

As illustrated in FIG. 18, while in a state in which the workspace 114 is open in the document pane 120, if a specifying operation such as a mouse right-click is performed on a blank portion of the document pane 120 (an area where no document icon 122 exists), the UI processing section 16 displays a context menu 180 for the workspace. The context menu 180 includes a menu item “Clean up” 182. By selecting the “Clean up” menu item, the user gives an instruction to temporarily clean up the current documents inside the workspace. Additionally, the user may also give an instruction to temporarily clean up the documents currently stored in the workspace 114 by pressing a button 136 inside the operation button area 130.

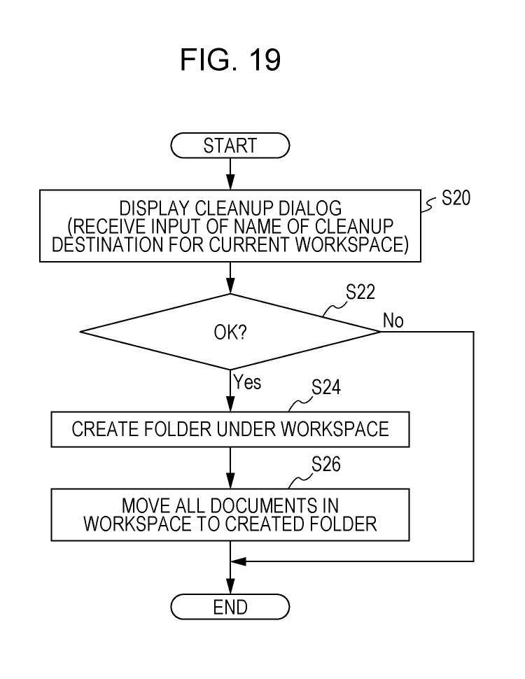

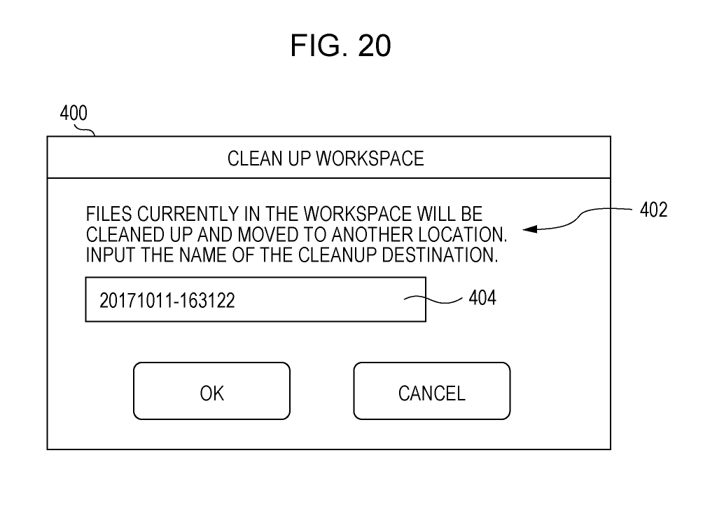

When the cleanup instruction is given, the cleanup processing section 20 (see FIG. 1) is launched. The cleanup processing section 20 executes the procedure illustrated in FIG. 19, for example. In this procedure, the cleanup processing section 20 first displays a cleanup dialog 400 (see FIG. 20) on the screen through the UI processing section 16 (S20). In the cleanup dialog 400, a message 402 prompting for the input of the name of a folder to newly create as the cleanup destination of the documents in the workspace, and a name input field 404 are displayed. When the input field 404 is first displayed, a default name generated in accordance with a preset naming rule (for example, a character string indicating the current date and time) is displayed in the input field 404. The user changes the name inside the input field 404 to a desired name as appropriate. In the case in which the user decides to create a cleanup folder with the name displayed in the input field 404, and clean up by moving the documents into the folder, the user presses an OK button. On the other hand, in the case of canceling the cleanup, the user presses a Cancel button. Note that in the case in which a cleanup folder with the same name input into the input field 404 of the cleanup dialog 400 already exists, the cleanup processing section 20 does not immediately create a cleanup folder with the name, and prompts the user to change the name input into the input field 404. Subsequently, in the case in which a different name from the existing cleanup folder is input, a new cleanup folder with the different name is created.

The cleanup processing section 20 determines whether the user has pressed the OK or Cancel button (S22), and if the Cancel button has been pressed, the cleanup processing section 20 ends the process.

If the OK button has been pressed, the cleanup processing section 20 creates a new folder (cleanup folder) with the name input into the input field 404 directly under the workspace 114 in the hierarchical structure of folders under the management of the document management system 10 (S24). Subsequently, the cleanup processing section 20 moves all documents inside the workspace to the cleanup folder created in S24 (S26). In other words, the documents are saved in the cleanup folder, and deleted from the workspace.

In this example, the cleanup folder is a subfolder (child folder) of the workspace, and is an exception to the general rule against the workspace containing child folders. Unlike the folders forming the hierarchical structure for organizing documents, the cleanup folder is a folder having a limited role of serving as a temporary evacuation location for the workspace. In this example, only such a cleanup folder is allowed to be positioned under the workspace. Note that unlike the folders forming the hierarchical structure for organizing documents, the cleanup folder being “under” the workspace does not have any particular meaning. The cleanup folder may also not be positioned under the workspace, insofar as the role of the cleanup folder as a cleanup destination for documents inside the workspace is indicated by attribute information of the cleanup folder or the like.

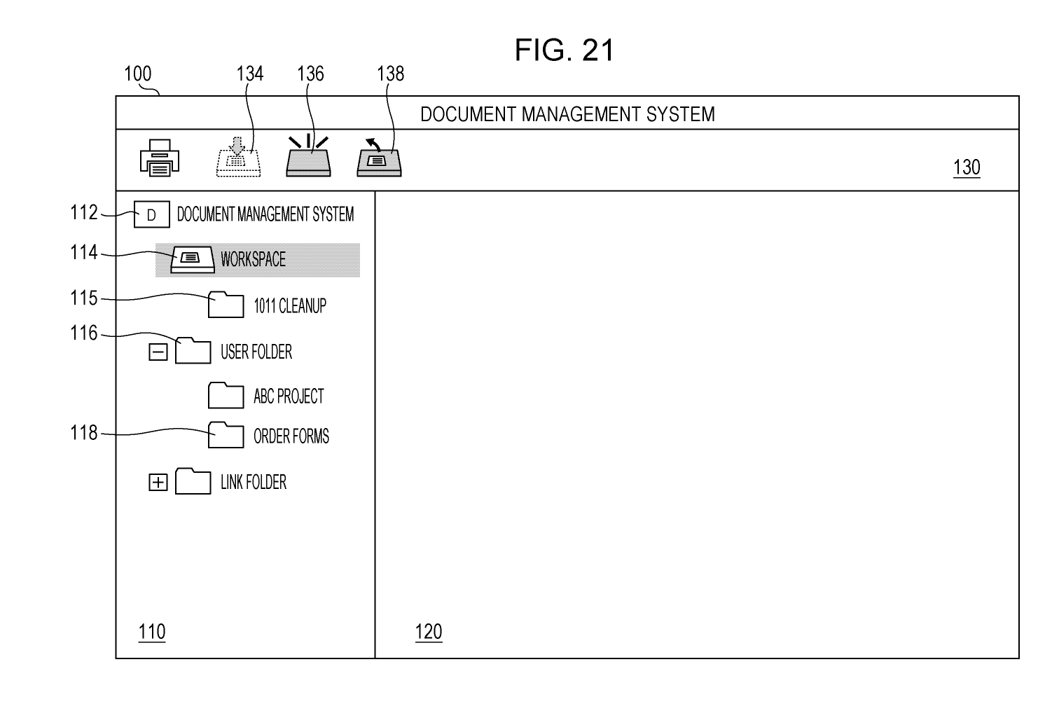

The result of the cleanup process becomes the displayed document management screen 100, for example, the screen illustrated in FIG. 21. In the document management screen 100 of FIG. 21, the icon of a cleanup folder 115 is displayed directly underneath the icon of the workspace 114 in the folder pane 110. Also, no document icons exist in the workspace being displayed in the document pane 120.

Note that after cleaning up the documents of the first work to the cleanup folder, the workspace is used to start the second work, and in the case in which it becomes desirable to perform yet another set of work while executing the second work, the documents for the second work in the workspace are also cleaned up. In this case, the cleanup processing section 20 creates a second cleanup folder different from the first cleanup folder directly underneath the workspace, and moves (evacuates) the current documents inside the workspace into this folder. In this way, multiple cleanup folders may be created.

The cleanup folder 115 is merely an evacuation destination for temporarily evacuating the documents for work that had been performed in the workspace, and performing work using the cleanup folder 115 is prohibited. This is to clarify the general rule of performing work using documents in the workspace.

Hypothetically, if the cleanup folder is opened in the document pane 120 and operations such as editing and adding or deleting documents are received, the distinction between the workspace and the cleanup folder would become unclear, and substantially lead to the existence of multiple workspaces. In the case in which the above is allowed, the user is burdened with the task of remembering whether the work that the user is currently engaged in is work in the workspace, or work in one of the cleanup folders. For example, suppose that the user opens a cleanup folder, and while using the documents inside to execute work, the user temporarily interrupts the work, and after closing the document management system 10, discovers a new document to use for the work. In the case of using the new document in the work, the user is burdened with the task of launching the document management system 10, specifying and opening the cleanup folder that had been open before the interruption, and saving the document in the cleanup folder. To specify the cleanup folder that had been open before the interruption, the user is burdened with the task of remembering which cleanup folder was being used for the most recent work. In addition, it is conceivable to copy the new document to use in the interrupted work to the workspace without opening the document management system 10, but using the “Copy to workspace” application 24 or the like, for example, but if the user was performing work in the cleanup folder before the interruption, it is a mistake to copy the document to the workspace (because the workspace is being used for different work than the work in the cleanup folder). On the other hand, if the user is asked to specify whether to copy the document to the workspace or the cleanup folder, the user becomes burdened with the task of remembering, similarly to the case of opening the document management system 10 and then copying a document to the cleanup folder before the interruption.

In contrast, by controlling work to be performed in the workspace, and making the cleanup folder unavailable as a work area (that is, editing and the like is not allowed), such problems are addressed or reduced.

The document processing section 14 may also receive an operation of opening the cleanup folder 115 onto the document pane 120, or an operation of opening a document inside the cleanup folder 115. This enables the user to check the contents of the cleanup folder, for example. However, to make the cleanup folder unavailable for use in work, operations for modifying the contents of documents inside the cleanup folder 115 (such as editing and deleting), and operations for adding a new document to the cleanup folder 115 or deleting a document from the cleanup folder 115 are not allowed. For example, in the case in which the user drops a document onto the cleanup folder 115 with a drag and drop operation, the document processing section 14 does not accept the drop operation, and instead displays, through the UI processing section 16, an error screen (not illustrated) indicating that adding a document to the cleanup folder is prohibited. Also, in the case in which the user performs an operation of opening a document inside the cleanup folder opened onto the document pane 120, the document processing section 14 opens the document on the screen in read-only mode (editing is unavailable).

It is also possible to think of the workspace as being “active” in the sense of accepting operations for modifying the contents, whereas the cleanup folder in which operations for modifying the contents are not allowed is an “inactive” workspace.

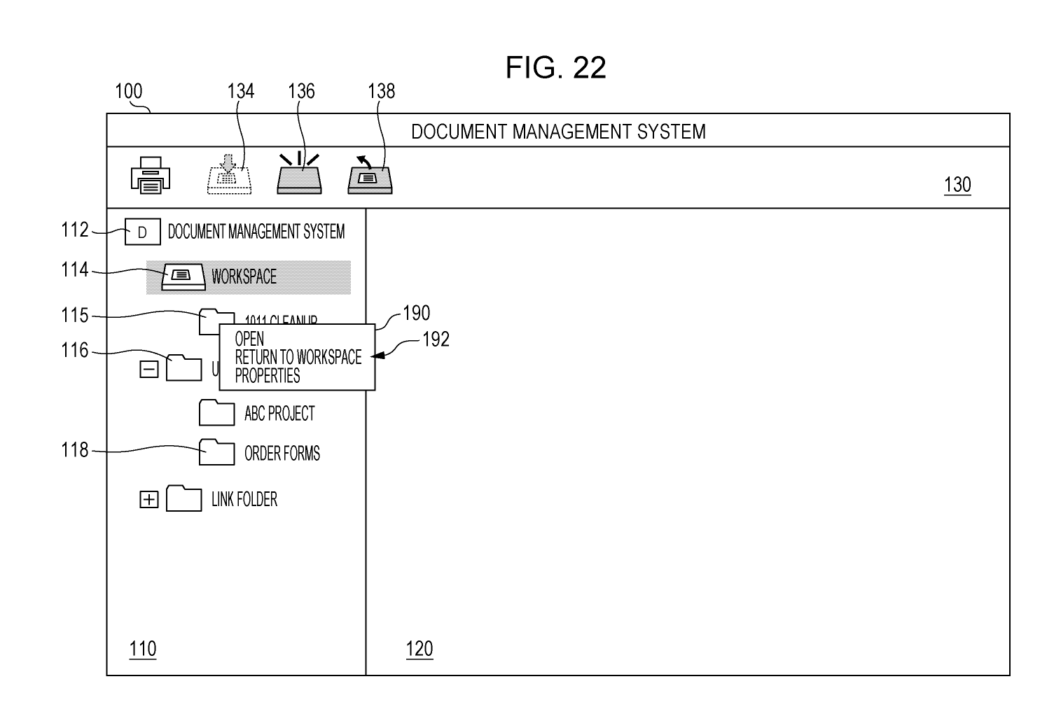

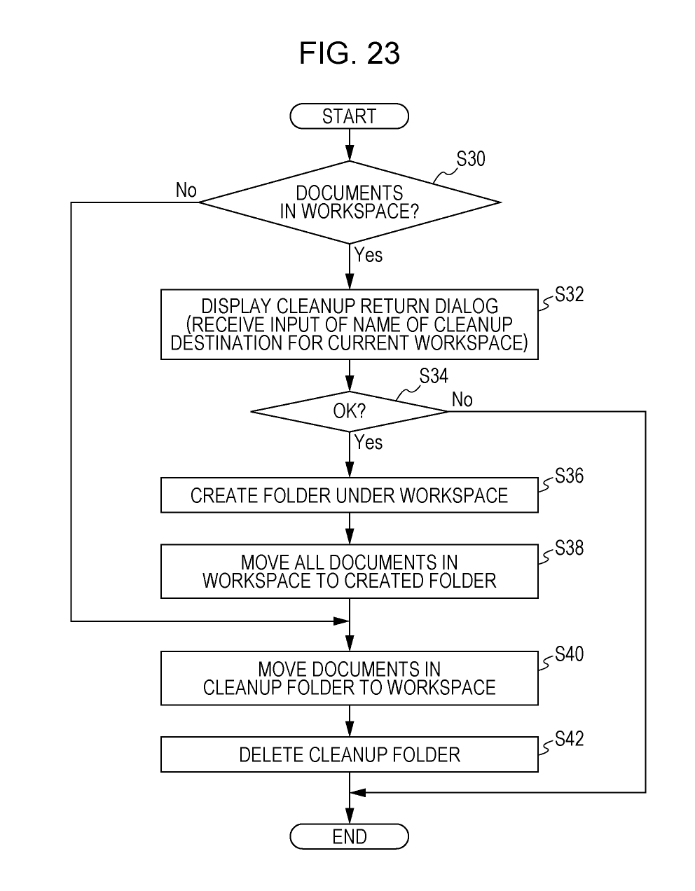

Next, the resuming of temporarily cleaned-up work will be described. In other words, the following describes a case in which, after the interrupting second work ends, the documents of the first work that had been cleaned up previously are redeployed onto the workspace, and the first work is resumed. In this case, the user opens a context menu 190 of the cleanup folder 115 for which the user wants to resume work from the folder pane 110 of the document management screen 100, as illustrated in FIG. 22. The context menu 190 includes a menu item 192 labeled “Return to workspace”. If the user selects the “Return to workspace” menu item with a click operation or the like, the cleanup processing section 20 executes a process for returning the documents in the cleanup folder to the workspace. FIG. 23 illustrates an example of a procedure for the process.

In the processing procedure of FIG. 23, in the case of receiving an instruction to return the cleanup folder to the workspace, the cleanup processing section 20 determines whether or not documents currently exist inside the workspace (S30). If documents do not currently exist inside the workspace, the cleanup processing section 20 moves all documents inside the cleanup folder to the workspace (S40), and after the move is completed, deletes the cleanup folder (S42).

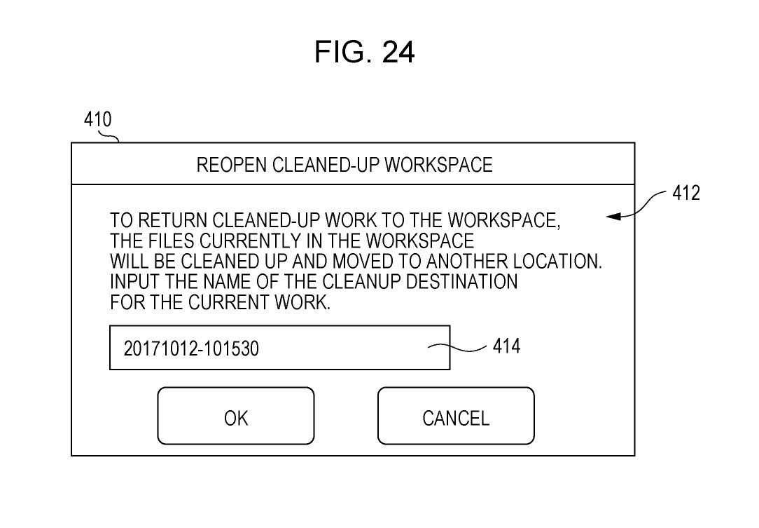

In S30, in the case of determining the documents currently exist inside the workspace, it is desirable to preserve the documents inside the workspace. In this case, the cleanup processing section 20 creates a cleanup folder in which to evacuate the documents currently inside the workspace, and moves the documents to the folder. In other words, the cleanup processing section 20 displays a cleanup return dialog 410 on the screen as illustrated by example in FIG. 24 (S32). The dialog 410 includes a message indicating that, to return the documents inside the cleanup folder to the workspace, the documents currently inside the workspace will be cleaned up, a message 412 prompting for the input of the name of a new folder for the cleanup, and an input field 414 for the name. In the input field 414, similarly to the input field 404 of the cleanup dialog 400 in FIG. 20, a default name is displayed, and the user is also able to change the name to a desired name. In the case in which the user decides to create a cleanup folder with the name displayed in the input field 414, and clean up by moving the documents inside the workspace into the folder, the user presses an OK button. On the other hand, in the case of canceling the cleanup, the user presses a Cancel button.

The cleanup processing section 20 determines whether the user has pressed the OK or Cancel button (S34), and if the Cancel button has been pressed, the cleanup processing section 20 ends the process. In this case, the cleanup folder that the user has selected as the return target and the workspace are both maintained in the current state.

If the OK button is pressed, the cleanup processing section 20 creates a new cleanup folder having the name inside the input field 414 at the level directly underneath the workspace 114 (S36), and moves all documents currently inside the workspace to the cleanup folder (S38). With this arrangement, the workspace becomes empty. After that, the cleanup processing section 20 moves all documents inside the cleanup folder selected as the return target to the workspace (S40). With this arrangement, the documents that had been inside the cleanup folder before are stored inside the workspace, and the cleanup folder becomes empty. The cleanup processing section 20 deletes the empty cleanup folder (S42).

Note that the documents inside the workspace include the information about the positions of the icons of the documents in the workspace (that is, the coordinates where the icons of the documents are positioned in the coordinate system of the document pane 120) as attributes. These attributes are maintained even for documents which are cleaned up from the workspace to the cleanup folder. When the cleanup folder is returned to the workspace, the icon is each document is placed at the position indicated by the attribute in the document pane 120.

In the above example, restrictions are imposed on the cleanup folder. Namely, operations that modify the contents of the cleanup folder, such as adding or deleting documents with respect to the cleanup folder, or editing documents inside the cleanup folder, are prohibited. However, some or all of these restrictions may also be canceled inactive the desires of the user. For example, the settings management section 18 may be given settings information about operations with respect to a cleanup folder, enabling the user to select whether each operation in the settings information (for example, adding or deleting documents with respect to the cleanup folder, and editing documents inside the cleanup folder) is available or unavailable.

In the above example, in the case of interrupting the current work to start new work, the documents inside the workspace are moved to a newly created folder to empty the workspace in response to a cleanup instruction, but instead, the workspace may be changed to an inactive state, a new workspace for the new work may be created, and the new workspace may be set to an active state. In this case, the document management system 10 manages the multiple stored workspaces so that one selected workspace from among the multiple workspaces is set to the active state, while the other workspaces are set to the inactive state. For the workspace in the active state, the document management system 10 allows operations for changing the contents of the workspace, such as adding or deleting and editing documents, whereas for the workspace or workspaces in the inactive state, the document management system 10 does not allow operations for changing the contents of the workspace. Among the multiple workspaces, the UI processing section 16 handles the active workspace as the workspace 114 inside the folder pane 110 of the document management screen 100, and handles each inactive workspace as a cleanup folder 115 inside the folder pane 110.

Also, for folders other than workspaces, a temporary cleanup process similar to the above-described may also be applied.

<Synchronization of Workspace>

A process of synchronizing the workspace inside the document management system 10 with a folder corresponding to the workspace inside another computer will be described. Herein, the synchronization of two folders (the workspace is also a type of folder) is a process of causing the sets of documents stored in the two folders to match each other. In other words, in two synchronized folders, a document stored in one folder is also stored in the other folder, and there are no documents which are stored in one folder, but not stored in the other folder. In addition, the same documents stored in the two folders match not only by the filename, but also by the contents and the last modified time.

Such workspace synchronization is utilized in cases like the following, for example. For example, one example is a case in which multiple users input the same documents into the workspaces of respective computers, and each uses the documents inside the workspace of one's own computer to proceed with work, thereby realizing pseudo-collaborative work. Also, in the case in which the same user works on a computer in a first location at one time, and performs the same work on a computer in a second location at another time, it is desirable to synchronize the workspaces inside these two computers. Also, even in the case of collaborative work, and even in the case in which the same user performs the same work on different computers at different times, it is conceivable to first synchronize the workspace inside a first computer with a folder corresponding to the workspace on a server such as a cloud server on the Internet, and then synchronize the workspace inside a second computer from the folder on the server. The following description takes as an example a case of synchronizing the workspace of the document management system 10 inside a certain computer with a corresponding folder on a cloud service.

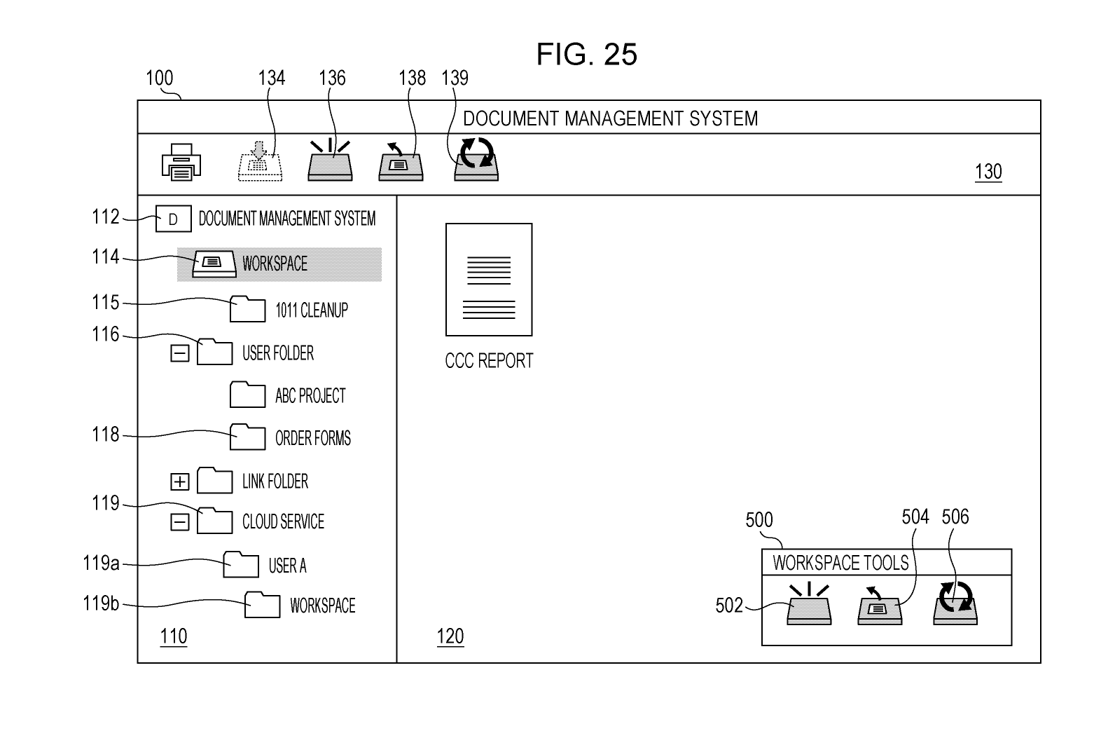

In this example, as illustrated by example in FIG. 25, the folder structure of the cloud service 119 utilized by the user is mounted with respect to the folder structure of the document management system 10. Inside the cloud service 119, a folder 119a is provided for the user (hypothetically named “user A”) who uses the document management system 10, and a workspace 119b is provided inside the folder 119a. The workspace 119b (whose actual data resides in the cloud service on the Internet) is a folder corresponding to the workspace of the user A inside the document management system 10, and is provided in order to synchronize with the workspace. In the example illustrated in the diagram, in the hierarchical structure of folders, the cleanup folder 115 exists underneath the workspace 114.

Also, a synchronize button 139 is provided in the operation button area 130. The synchronize button 139 is a button for issuing an instruction to execute synchronization between the workspace inside the document management system 10 and the workspace folder inside the cloud service 119.

In the example of FIG. 25, the workspace is open in the document pane 120 of the document management screen 100. In this state, the clean up button 136, the “Source location” button 138, and the synchronize button 139 inside the operation button area 130 are in the active state (that is, a state allowing selection by the user), while the “Copy to workspace” button 134 is in a non-selectable state (displayed with low contrast, and the user is unable to select the operation). Also, inside the document pane 120, a toolbox 500 for the workspace is displayed. the toolbox 500 includes a clean up button 502, a “Source location” button 504, and a synchronize button 506. These buttons 502 to 506 have the same function as the buttons of the same names inside the operation button area 130. (Note that even in the example described using FIG. 4 and the like, a similar workspace toolbox 500 may also be displayed inside the document pane 120 displaying the workspace.)

In this example, in the state in which the workspace 114 is open in the document pane 120, by pressing the synchronize button 139 or 506 (for example, selecting with a mouse click operation or the like), the workspace 114 and the workspace 119b inside the cloud service 119 may be synchronized. In other words, in response to pressing the synchronize button 139 or the like, the synchronization processing section 22 (see FIG. 1) is launched. The synchronization processing section 22 copies documents, deletes documents, and the like (details will be illustrated by example in the later section “Resolving mismatches during synchronization”), so that the sets of documents stored in the workspace 114 inside the document management system 10 and the workspace 119b inside the cloud service 119 match each other.

Also, although omitted from illustration in the diagrams, a menu item for synchronizing with the cloud may be displayed on a context menu called with respect to an icon in the workspace 114 of the folder pane 110, and synchronization may be executed by selecting the menu item.

The object of synchronization when the synchronization processing section 22 executes the synchronization process between the workspace 114 and the workspace 119b is only the documents inside the workspaces 114 and 119b. Even if subfolders (that is, cleanup folders) exist inside the workspaces 114 and 119b, as a general rule, the synchronization processing section 22 does not automatically synchronize subfolders when synchronizing workspaces. With this arrangement, the amount of communication between the document management system 10 and the cloud service during workspace synchronization may be reduced potentially.

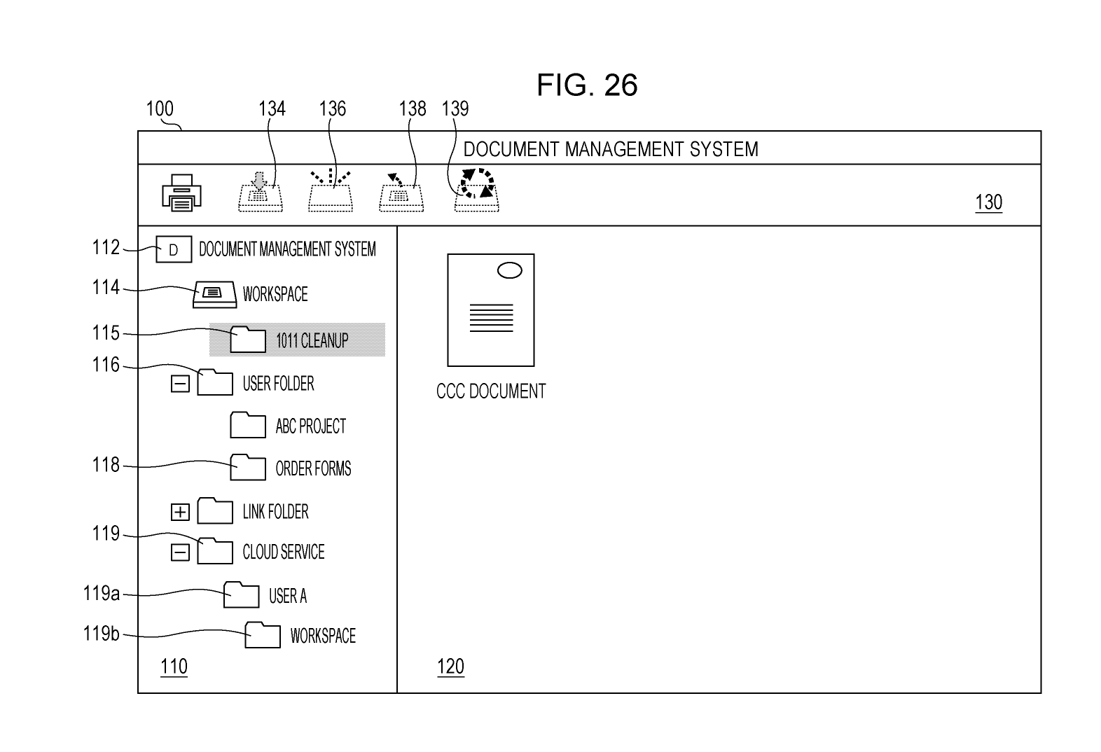

FIG. 26 illustrates an example of the document management screen 100 in a state in which the cleanup folder 115 is open in the document pane 120. In the state in which the cleanup folder 115 is open, the “Copy to workspace” button 134, the clean up button 136, the “Source location” button 138, and the synchronize button 139 inside the operation button area 130 are in a non-selectable state, and a toolbox corresponding to the workspace toolbox 500 is also not displayed. Consequently, for the cleanup folder 115, synchronizing with the cloud service is not available, at least not by a one-touch operation. Note that a menu item for synchronizing with the cloud may also be displayed on a context menu called from the icon of the cleanup folder 115 or the document pane 120, and the cleanup folder 115 may be synchronized with the cloud service by selecting the menu item.

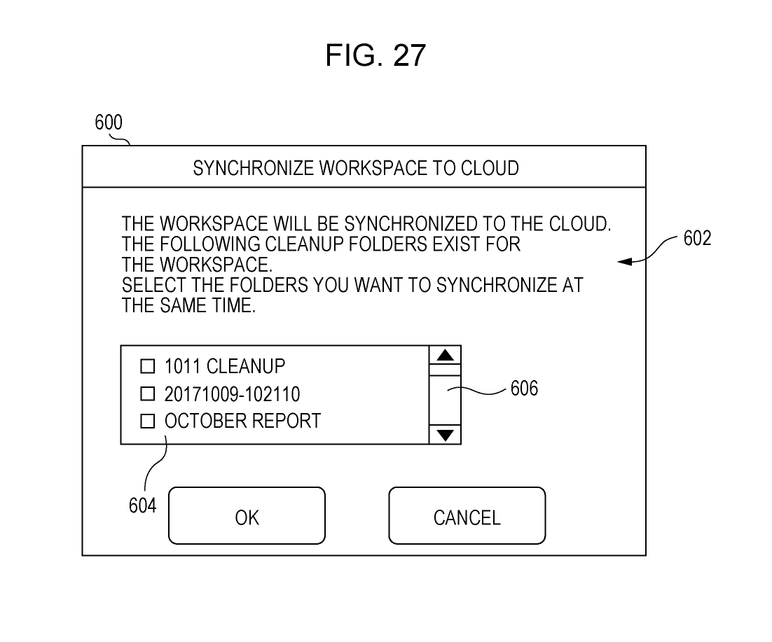

As described above, as a general rule, the cleanup folder 115 is not synchronized with the cloud service when the workspace is synchronized with the cloud service. However, when the user gives an instruction to synchronize the workspace, the synchronization processing section 22 may also query the user whether to synchronize the cleanup folder at the same time. An example of a query screen 600 displayed by the synchronization processing section 22 for the query is illustrated in FIG. 27. The query screen 600 includes a message 602 prompting the user to select which cleanup folders are to be synchronized at the same time the workspace is synchronized with the cloud, and a display field 604 that displays a list of cleanup folders which may be selected. In the display field 604, the names of cleanup folders included in the workspace are listed. On the left side of the names of the cleanup folders in the list, checkboxes are displayed, and by putting a check mark in the checkboxes, the user selects which cleanup folders to synchronize. In the case in which there are a large number of cleanup folders, and not all are displayed at one time in the display field 604, the display range is scrolled with a scrollbar 606 on the edge of the display field 604. Herein, the order in which the cleanup folders are displayed in the list in the display field 604 may be the order by newest created time of the cleanup folders, for example. With this arrangement, when the query screen is opened, the cleanup folder with the most recent created time is displayed at the top of the display field 604, and other cleanup folders are arranged below in order of newest created time.

If there is a cleanup folder that the user wants to synchronize at the same time as the workspace, the user input a check mark into the checkbox to express one's intent, and then presses an OK button. With this arrangement, the synchronization processing section 22 synchronizes the workspace and each selected cleanup folder with each corresponding folder on the cloud service side.

In the above example, workspace synchronization is executed in response to a user instruction, but instead, synchronization may also be executed automatically at periodic timings or the like, for example. For example, synchronization may be executed automatically when the document management system 10 is started up.

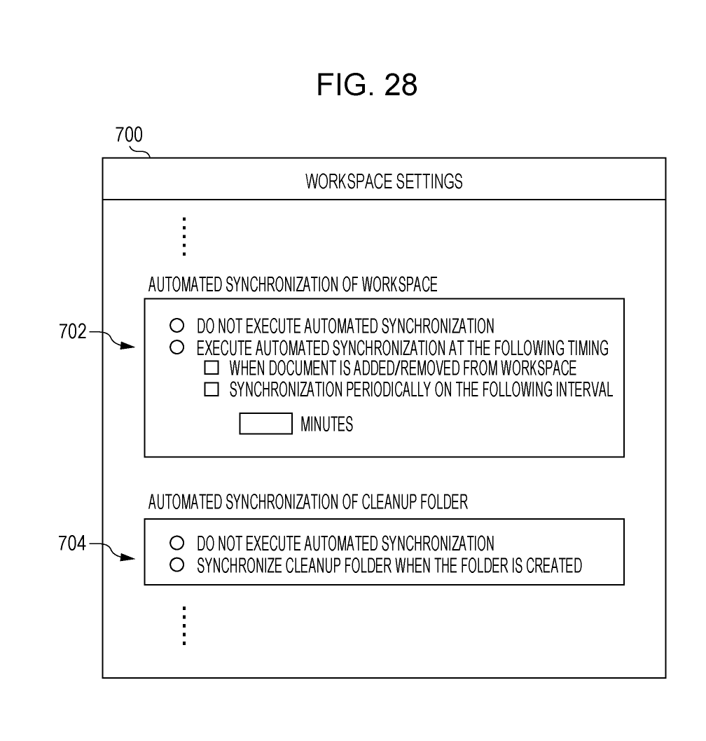

Also, user settings regarding automatic synchronization may also be received. FIG. 28 is a diagram illustrating an example of a settings screen 700 for the workspace that includes automatic synchronization settings. The settings screen 700 includes a setting field 702 regarding automatic synchronization of the workspace, and a setting field 704 regarding automatic synchronization of cleanup folders. In the setting field 702 regarding automatic synchronization of the workspace, a selection option for not executing automatic synchronization and a selection option for executing automatic synchronization are selectable by radio buttons, and for the latter selection option, timings at which to execute automatic synchronization are listed with checkboxes, enabling the user to select one or more of these timings. The listed selection options for the timings of automatic synchronization of the workspace include the timing when a change occurs in the workspace, such as when a document is added or deleted, and periodic timings. For the latter, the user is able to set the interval between the periodic timings. Also, in the setting field 704 for automatic synchronization of cleanup folders, two selection options, namely a selection option for not executing automatic synchronization and a selection option for executing automatic synchronization when the cleanup folder is created, are selectable by radio buttons. Note that the selection options illustrated by example in FIG. 28 are merely examples, and other selection options may also exist, for example.

As described above, in this example, the workspace may be synchronized with the cloud service by a one-touch operation, but synchronization of a cleanup folder with the cloud service is not accepted, or even if accepted, involves a more complex operation (for example, selection by calling a context menu) than the case of the workspace. Also, the timing of automatic synchronization of the cleanup folder is more limited than that of the workspace.

Note that instead of using a workspace and a cleanup folder or folders, similar synchronization control is also applicable to the method of using an active workspace and an inactive workspace or workspaces described earlier. In this case, it is sufficient to handle the active workspace as the workspace in the above synchronization process, and handle the inactive workspace or workspaces as the cleanup folder in the above synchronization process.

<Resolving Mismatches During Synchronization>

Next, the synchronization process between the workspace 114 inside the document management system 10 and the corresponding folder (workspace 119b) on the cloud service side will be described further.

For the synchronization process, the synchronization processing section 22 manages a synchronization management file. The synchronization management file records the modified time of each document inside the workspace 114 and the corresponding folder on the cloud service side from the time when the previous synchronization was executed. Every time synchronization is executed, the synchronization processing section 22 checks the modified time of each document inside the workspace and the corresponding folder on the cloud service side after the synchronization is completed, and updates the synchronization management file accordingly.

When executing the synchronization process, the synchronization processing section 22, by referencing the synchronization management file, detects the addition, deletion, and modification of documents inside the workspace of the document management system 10 and the corresponding folder of the cloud service.

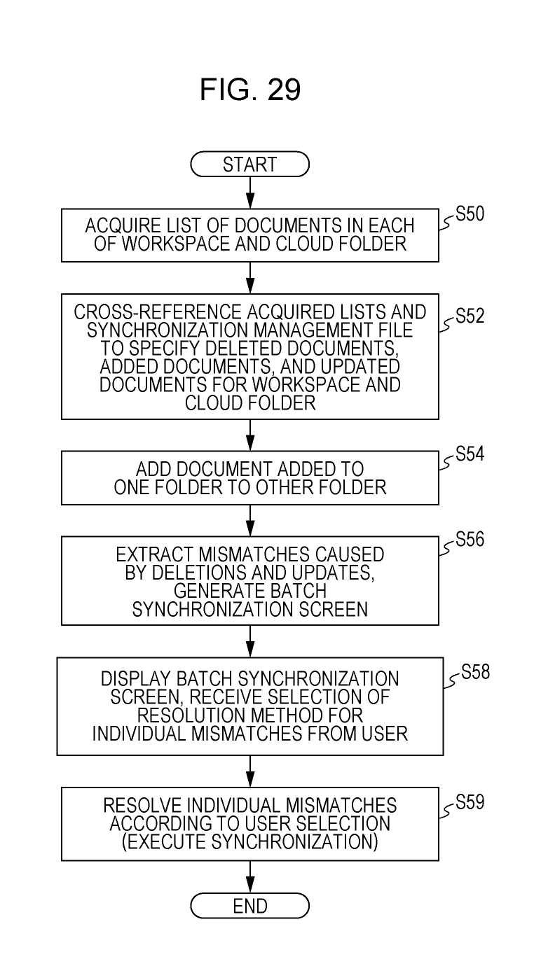

FIG. 29 illustrates an example of a procedure for the synchronization process executed by the synchronization processing section 22. In this procedure, the synchronization processing section 22 first acquires a list of documents existing inside the workspace of the document management system 10, and a list of documents existing inside the synchronization target, namely the corresponding folder of the cloud service (S50).

Next, the synchronization processing section 22 cross-references the document list of the workspace and the document list of the corresponding folder acquired in S50 with the synchronization management file (S52). In the cross-reference, for example, in the case in which a document on the document list of the workspace is not recorded in the synchronization management file, the document may be determined to be a document which has been added to the workspace after the previous synchronization. Also, for example, in the case in which a document recorded in the synchronization management file is not on the document list of the workspace, it may be determined that the document has been deleted from the workspace. Also, if the modified time of a document on the document list of the workspace is later than the modified time of the same document recorded in the synchronization management file, it may be determined that the document inside the workspace has been updated. Similar determinations are also made for documents inside the corresponding folder on the cloud service side.

Next, the synchronization processing section 22 uploads the documents determined to have been added to the workspace in S52 to the corresponding folder on the cloud service side, and similarly downloads documents determined to have been added to the corresponding folder on the cloud service side to the workspace (S54). Also, in the case of determining that a document recorded in the synchronization management file has been updated in one of either the workspace or the cloud service, but has not been updated in the other, the synchronization processing section 22 may cause the updates to be reflected in the other. For example, in the case in which a document inside the workspace has been updated, but the same document on the cloud service side has not been updated, the document inside the workspace overwrites the same document inside the corresponding folder on the cloud service side.

Next, on the basis of the information obtained in S52, the synchronization processing section 22 lists mismatches between the documents in the workspace and the corresponding folder in the cloud which are caused by the deletion or updating of documents, and generates a batch synchronization screen for receiving a resolution method specified by the user for each mismatch (S56).

The mismatches extracted at this point are limited to those that demand a judgment from the user. For example, the documents processed in S54, such as a document added to either of the workspace and the corresponding folder in the cloud, or a document updated in one but not updated in the other, are mismatches in the broad sense, but for these documents, it is obvious to prioritize the added document or the updated document, and a judgment from the user is not demanded. Also, in the case in which a document recorded in the synchronization management file has been deleted from both the workspace and the corresponding folder in the cloud, it is obvious that the document is unwanted by the user, and a judgment from the user is not demanded during synchronization.

The mismatches extracted in S56 include the following cases. One is the case in which a document is deleted from one of the workspace and the corresponding folder on the cloud service side, but the document still remains in the other. In this case, since the user may want to use the remaining document, the user is queried for a resolution method for the mismatch (one-sided deletion). Also, a second case is the case in which the same document is updated in both the workspace and the corresponding folder in the cloud. This case is called a conflict. In the case of a conflict, the user is queried about which update to treat as valid (that is, which document to adopt for synchronization). The batch synchronization screen is configured to receive the selection of a resolution method from the user for each mismatch corresponding to these cases. The batch synchronization screen will be described later.

Next, the synchronization processing section 22 displays the batch synchronization screen, and receives the selection of a resolution method (action) for the individual mismatches from the user (S58). Subsequently, the mismatches are resolved according to the resolution methods selected by the user (S59). By resolving the mismatches (and executing the process of S54), synchronization is realized between the workspace and the corresponding folder on the cloud service side.

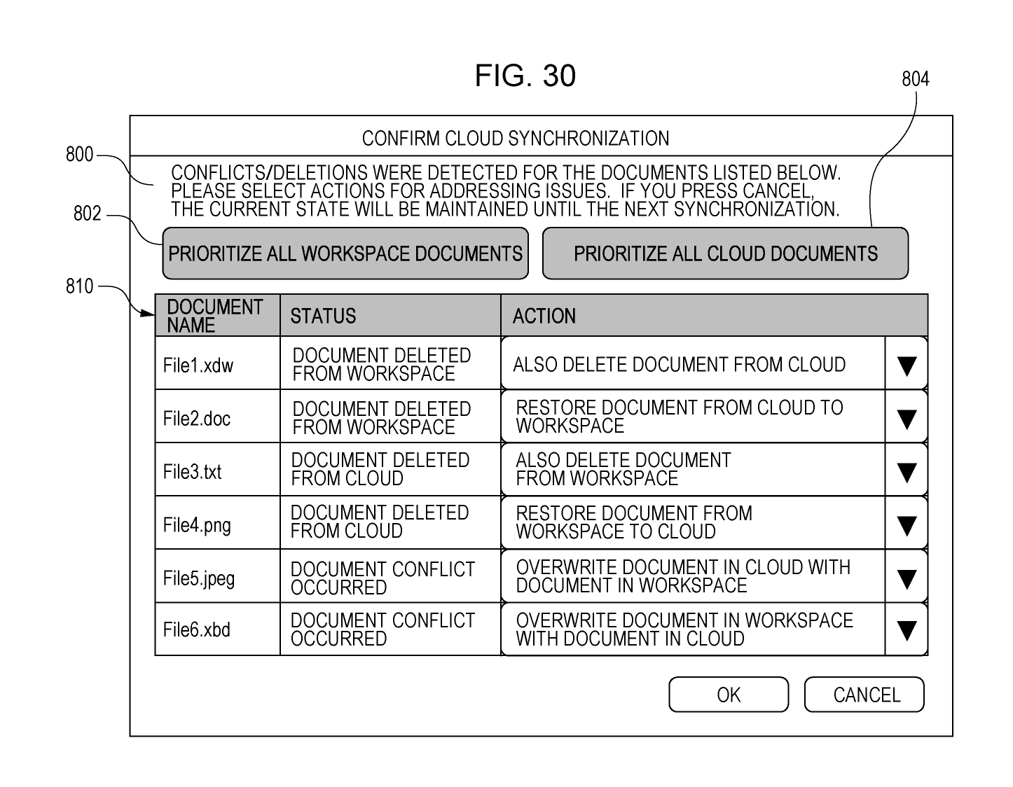

The above thus describes an example of a procedure for a synchronization process. Next, an example of the batch synchronization screen 800 displayed in S58 will be described with reference to FIG. 30. The batch synchronization screen 800 includes a messages prompting action by the user, a prioritize workspace button 802, a prioritize cloud button 804, and a mismatch list 810.

In the mismatch list 810, the mismatches extracted in S56 are listed. The mismatch list 810 includes, for each mismatch, the document name (file name) of the document in which the mismatch is detected, text explaining the “status” of the mismatch, and an action (resolution method) item for resolving the mismatch. The action item is configured as a pull-down menu, with the menu listing selection options for actions for resolving the mismatch “status”. The user is able to select an action for resolving the mismatch from the pull-down menu.

The prioritize workspace button 802 is a button for selecting actions that prioritize the documents on the workspace side for all mismatches in the mismatch list 810. Also, the prioritize cloud button 804 is a button for selecting actions that prioritize the documents inside the corresponding folder on the cloud service side for all mismatches in the mismatch list 810.

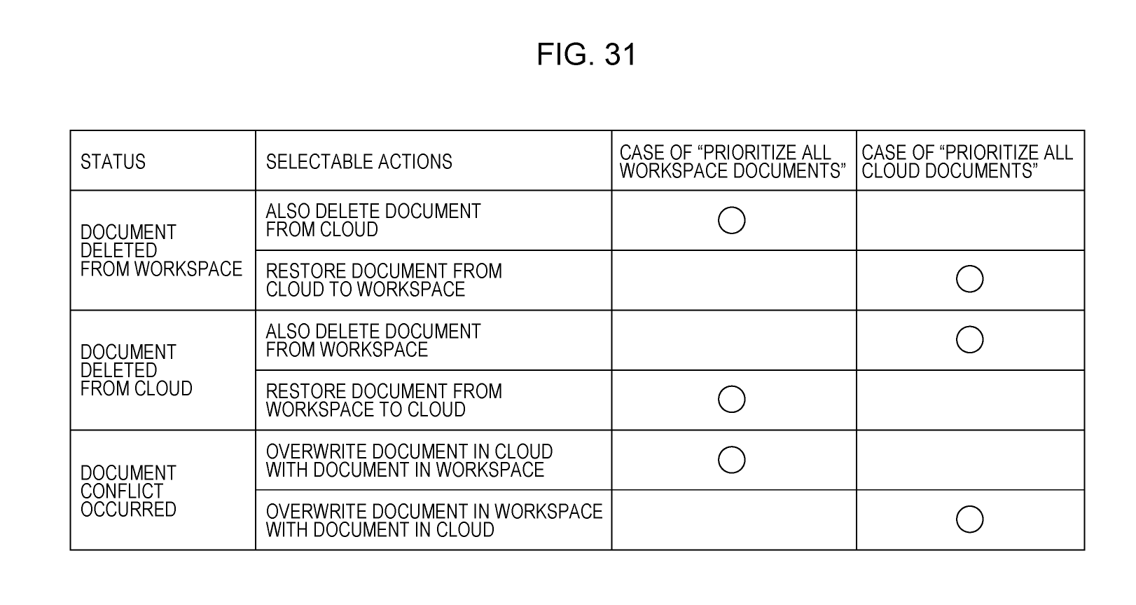

FIG. 31 illustrates an example of a determination table for each “status” of mismatch. The table indicates, for each “status”, the selection options for actions which may be selected from the pull-down menu, and which of these selection options is selected when the prioritize workspace button 802 and the prioritize cloud button 804 are pressed. For example, for the mismatch status in which a document is deleted from the workspace (the same document still remains in the cloud), the selection operations for actions which may be selected include an action of also deleting the document from the cloud, and an action of restoring the document from the cloud to the workspace (that is, downloading the document in the cloud to the workspace). Additionally, between these selection options, the selection option which is selected when each of the prioritize workspace button 802 and the prioritize cloud button 804 is pressed is indicated by a circle mark. For example, in the case in which the prioritize workspace button 802 is pressed, the action of deleting the document from the cloud is selected, whereas in the case in which the prioritize cloud button 804 is pressed, the action of restoring the document from the cloud to the workspace is selected.

If the prioritize workspace button 802 is pressed on the batch synchronization screen 800, the synchronization processing section 22 changes the pull-down menu of actions corresponding to each document in the mismatch list 810 to a state in which the selection option for when the prioritize workspace button 802 is pressed in the determination table of FIG. 31 is selected. Also, if the prioritize cloud button 804 is pressed, the synchronization processing section 22 changes the pull-down menu of actions corresponding to each document in the mismatch list 810 to a state in which the selection option for when the prioritize cloud button 804 is pressed in the determination table of FIG. 31 is selected. After selecting an action for each document with a mismatch all at once with the prioritize workspace button 802 or the prioritize cloud button 804, the user is also able to re-select actions for individual documents with the pull-down menus. Additionally, it is also possible to again re-select actions all at once by the prioritize workspace button 802 or the prioritize cloud button 804.

When the user presses an OK button on the batch synchronization screen 800, the action selected at that time for each document in the mismatch list 810 becomes the action of the synchronization process (mismatch resolution) applied to each document. The synchronization processing section 22 executes the selected action for each document.

Also, on the batch synchronization screen 800 illustrated by example in FIG. 30, a selection locking mechanism (for example, a GUI button) for locking a selection may be provided in correspondence with the action pull-down menus of the individual documents with a mismatch. For the pull-down menu of a mismatched document whose selection option has been locked by the selection locking mechanism according to a user instruction, the selection state does not change (that is, the locked selection option is maintained), even if the prioritize workspace button 802 or the prioritize cloud button 804 is pressed.

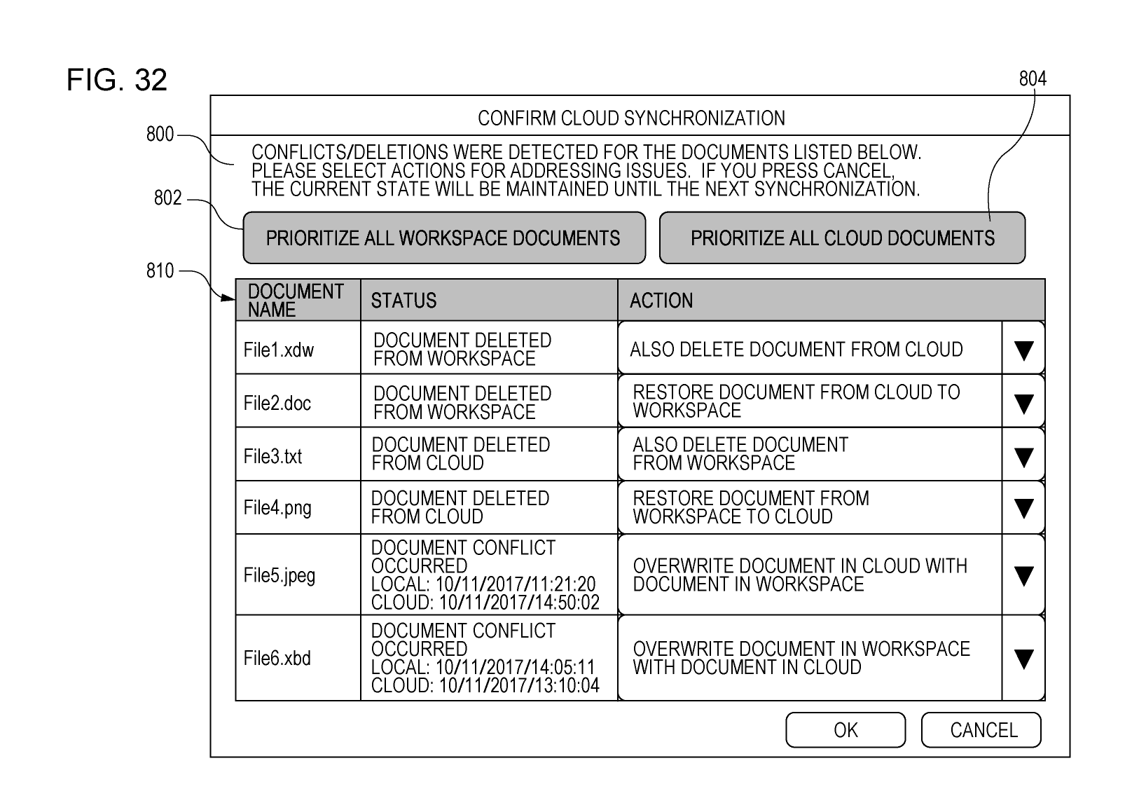

Also, as illustrated in FIG. 32, among the types of mismatches illustrated on the batch synchronization screen 800, for an update conflict between the local (document management system 10) side and the cloud service side, the modified time of each of the local document and the cloud document may also be displayed. Such a display of modified times serves as reference information when the user judges whether to adopt the local update or the cloud update. Note that although a process in which the synchronization processing section 22 automatically selects the document with the newer modified time is conceivable, the user may want to select the older update deliberately in some cases, and thus in this example, the user is asked to make a judgment.

Also, in the example of FIGS. 30 and 31, for a document in which an update conflict has occurred, the selection options of the action are the two selection options of overwriting the document in one of either the workspace or the corresponding folder in the cloud with the document in the other location. In addition to the above, a selection option of “rename and save both” may also be added to the selection options for the case of a conflict. This selection option is a process of renaming the document related to the conflict included in the workspace and uploading the renamed document to the cloud, while in addition, downloading the document related to the conflict in the cloud (which is not renamed) to one's own side. To give merely one example of the renaming method, a method of adding a specific delimiting character (for example, a hyphen) and a sequential number (a number that does not overlap with numbers already added to the same document name so far) to the end of the original document name, for example, may be used. In addition, the document in the cloud may also be renamed instead of renaming the document in the workspace. Also, between the document in the workspace and the document in the cloud, the document chosen according to a specific criterion (for example, the document with the older modified time) may be renamed. According to the synchronization process of this selection option, by renaming one of the documents related to the conflict in the workspace and the cloud, both versions are saved both in the workspace and in the cloud.

The document management system 10 and the “Copy to workspace” application 24 exemplified above may also be realized by causing a computer to execute a program expressing the functions of each of these devices, for illustrative purposes. Herein, the computer includes hardware having a circuit configuration in which a microprocessor such as a CPU, memory (first storage) such as random access memory (RAM) and read-only memory (ROM), a hard disk drive (HDD) controller that controls an HDD, various input/output (I/O) interfaces, a network interface that controls connections to a network such as a local area network, and the like are interconnected via a bus, for example. Additionally, components such as a disc drive for reading and/or writing a portable disc recording medium such as a CD or DVD, or a memory reader/writer for reading and/or writing portable non-volatile recording media of various standards such as flash memory, may be connected to the bus via an I/O interface, for example. A program stating the processing details of each function module exemplified in the foregoing is saved in a fixed storage device such as a hard disk drive and installed in the computer via a recording medium such as a CD or DVD, or via a communication medium such as a network. By having the CPU or other microprocessor load the program stored in the fixed storage device into RAM and execute the program, the function module group exemplified in the foregoing is realized.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a storage processing unit that, in a case of storing a document or a copy of the document inside a storage area in a different specific storage area, executes a process of setting information indicating the storage area in an attribute indicating an original storage location of the document to store, and storing the document in the specific storage area.

2. The information processing device according to claim 1, further comprising:
a list display unit that displays a list of documents inside the specific storage area in a display format expressing the original storage location indicated by the attribute of each document.

3. The information processing device according to claim 2, wherein
in the list display, the list display unit indicates the original storage location of each document inside the specific storage area with a character string.

4. The information processing device according to claim 2, wherein
in the list display, the list display unit displays each document inside the specific storage area in a different display mode for each original storage location of the documents.

5. The information processing device according to claim 1, further comprising:
a first list display unit that displays a list of documents inside the storage area indicated by the original storage location of a document inside the specific storage area.

6. The information processing device according to claim 5, further comprising:
a second list display unit that displays a list of documents inside the specific storage area, wherein
the first list display unit displays a list of documents inside the storage area indicated by the original storage location corresponding to a document selected from the list of documents inside the specific storage area, and
in the list of documents inside the specific storage area, the second list display unit displays the selected document in a display mode distinguishable from other documents.

7. The information processing device according to claim 6, wherein
among the documents in the list display of the first list display unit, a document corresponding to the selected document inside the specific storage area is displayed in a display mode distinguishable from other documents.

8. The information processing device according to claim 6, wherein
the second list display unit displays the documents inside the specific storage area in a display format expressing the original storage location indicated by the attribute of each document.

9. The information processing device according to claim 7, wherein
the second list display unit displays the documents inside the specific storage area in a display format expressing the original storage location indicated by the attribute of each document.

10. The information processing device according to claim 1, further comprising:
a write-back unit that writes back a document inside the specific storage area to the storage area indicated by the attribute included in the document.

11. An information processing device comprising:
a storage unit that, for each document stored in a specific storage area, stores an attribute expressing a storage location of a storage source when the document is stored in the specific storage area; and
a list display unit that displays a list of documents inside the specific storage area in a display format expressing the storage location of the storage source indicated by the attribute of each document.

12. The information processing device according to claim 11, wherein
in the list display, the list display unit indicates the storage location the storage source of each document inside the specific storage area with a character string.

13. The information processing device according to claim 11, wherein
in the list display, the list display unit displays each document inside the specific storage area in a different display mode for each storage location of the storage source of the documents.

14. A non-transitory computer readable medium storing a program causing a computer to execute a process for processing information, the process comprising:
executing, in a case of storing a document or a copy of the document inside a storage area in a different specific storage area, a process of setting information indicating the storage area in an attribute indicating an original storage location of the document to store, and storing the document in the specific storage area.

15. A non-transitory computer readable medium storing a program causing a computer to execute a process for processing information, the process comprising:
storing, for each document stored in a specific storage area, an attribute expressing a storage location of a storage source when the document is stored in the specific storage area; and
displaying a list of documents inside the specific storage area in a display format expressing the storage location of the storage source indicated by the attribute of each document.
